(19) United States
(12) Patent Application Publication
(10) Pub. No.: US 2002/0120546 A1
(43) Pub. Date: Aug. 29, 2002

(54) Mutli-interface financial transaction system and method

(76) Inventor: Paul Zajac, Hoboken, NJ (US)

Correspondence Address: PILLSBURY WINTHROP, LLP, P.O. BOX 10500, MCLEAN, VA, 22102, US

(21) Appl. No.: 09/737,804

(22) Filed: Dec. 18, 2000

(51) Int. Cl. G06F 17/60

(52) U.S. Cl. 705/37

(57) ABSTRACT

A system, and its components and processes, receive, manage and output data received from at least two IDBs and at least one financial instrument dealer. In accordance with the exemplary embodiments of the invention, a platform provides the user with a single user interface for viewing and executing trades on multiple Inter-dealer broker electronic trading systems.

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### FIELD OF THE INVENTION

The exemplary embodiments of the present invention are directed generally to a system and method for outputting and receiving data associated with the trading of financial instruments.

### BACKGROUND

In terms of the number of issues outstanding, trading volume, and manner of trading, the fixed income market, or bond market, is one of the largest and most complex marketplaces in the world. The bond market comprises two broad categories of securities: riskless securities and securities with credit risk. The former category includes U.S. treasury securities, securities from federally sponsored agencies, and sovereign debt of certain foreign countries, such as United Kingdom gilts. The latter category includes all fixed income securities for which there is a risk of default. Securities may include, for example, U.S. Treasuries, agencies, repurchase contracts (“repos”), mortgage passthroughs (“TBAs”), investment grade corporate debt, municipal debt (“munis”), emerging market debt, etc.

Presently, the U.S. bond market, which includes both Treasuries and non-government fixed income securities, comprises about $15 trillion in outstanding issues, compared with about $22 trillion in total capitalization of companies traded on the Nasdaq and NYSE. While the U.S. equity markets comprise fewer than 9,000 securities, the fixed income markets are significantly more complex, with millions of distinct issues differentiated by issuer, size, term, and rate parameters. In terms of trading volume, over $350 billion in bonds trade on a daily basis in the U.S. bond market.

Recently, the U.S. bond market has experienced underlying change in terms of a shift in liquidity, as well as in the balance of power between the buy- and sell-sides. Rising interest rates and budget surpluses have curtailed the new-issue Treasury market, while at the same time, there has been a trend towards shorter maturity Treasuries, with the ten-year bond replacing the long bond as the industry bellwether.

The corporate bond market has grown in tandem with the strong U.S. economy so that corporate bond issues currently represent the largest single fixed income new issue category. Industry consolidation and realigned risk strategies have reduced the availability of dealer capital in the bond market. At the same time, large buy-side institutions now represent significant pools of liquidity in the market.

Most Treasuries are traded through one of twenty-six primary dealers. These same dealers have a dominant position in trading other U.S. fixed income securities. It is estimated that there are approximately two hundred smaller dealers and over 1,000 buy-side firms that invest in fixed income securities.

The absence of a consolidated trading platform for the vast majority of fixed income securities necessitates the role of Inter-Dealer Brokers (IDBs), who provide an anonymous marketplace in which dealers acting on behalf of their clients, or as principals, can buy and sell bonds with each other. While there are many IDBs, almost all trading in Treasury securities (the single largest fixed income asset class) has been effected through three primary IDBs: Cantor-Fitzgerald, Garban-Intercapital, and Tullet Tokyo-Liberty. There are two emerging IDBs, Instinet Fixed Income and BrokerTec. While the major IDBs are also dominant brokers in the market for other fixed income securities; there are many other IDBs.

Historically, trading in the fixed income markets has relied on the telephone as the principal channel for communication. Dealers and institutional investors typically negotiate transactions or directly match bids and offers through IDBs. In this way, the IDBs ensure price transparency and trade execution. Prices of transactions are reported by the IDBs to the market data vendors. Thus, the tools of a typical bond trader traditionally include a telephone and a market data terminal (such as those offered by Reuters, Bloomberg, and Bridge/Telerate).

However, the voice-centric trading environment is being phased out in favor of electronic trading systems. These systems offered by the IDBs and others link all market participants and remove many of the inefficiencies inherent in the traditional trading environment. Reduction of the number of nodes of human interface makes trading quicker and less costly, and reduces the risk of error. Each electronic network represents a unique market, providing bid and offer prices as well as some degree of price transparency to the market. Another potential benefit of these emerging systems is the facilitation of straight through processing (STP) through interfaces between the trading desk and back-office systems for trade clearance, confirmation, and settlement.

The front end for the electronic trading systems conventionally offered by the IDBs generally runs on a desktop computer. These conventional systems are differentiated from those of most market data vendors in that they are bi-directional so that in addition to providing market data, these can act as a conduit for trade execution.

Currently, eSpeed, a publicly traded company spun-off from Cantor-Fitzgerald, is the most widely used electronic IDB solution. Other systems, primarily for Treasury securities, include Garban's Electronic Trading Community platform (ETC), Liberty's Liberty Direct, Instinet Fixed Income and the BrokerTec platform (owned by a consortium of major dealers). Besides these traditional players, as many as fifty competing electronic platforms have emerged. These are generically referred to as alternative trading systems (ATSs), although many provide only news and analytics rather than execution.

Accordingly, it is foreseeable that all dealers in the fixed income markets will have to trade electronically with IDBs, e.g., Cantor Liberty Direct, Instinet, Garban, Broker Tec, etc., in the near future.

### SUMMARY OF THE INVENTION

Thus, each IDB provides a data feed to the dealer that includes information about the price, quantity and other particulars of the financial instruments the IDB has for sale. Just as one IDB works with multiple dealers, it is not uncommon for one dealer to work with multiple IDBs. As a result, such dealers received multiple data feeds associated with respective IDBs. Although some larger dealers may have developed proprietary aggregation solutions for handling multiple IDB feeds, there is no platform independent, single interface, IDB data feed compiler available.

The exemplary embodiments of the present invention are directed generally to a system, its components and a method for managing and outputting data received from multiple IDBs and receiving related data from a dealer. In accordance with the exemplary embodiments of the invention, a platform provides a user with a single user interface for viewing and executing trades on multiple IDB systems.

According to the exemplary embodiments of the invention, a multi-IDB interface system may be implemented to provide a client application that is deployed to a user's trading desk. Corresponding server side processes may reside on system servers and run over a local area network at a user's site. Alternatively, server side processes may be located at an Application Service Provider and client application functionality may be delivered via the Internet.

Such a multi-IDB interface system may include various functionality, e.g., built in authentication and entitlements, consolidation of prices and sizes across a minimum of two IDBs, display of bid and offer prices and sizes separately, display of a consolidated stack or a specific IDB stack, hitting or lifting of current market from any IDB, transmission of orders (bid/offer) to a minimum of two IDBs, cancellation of orders, receipt confirmations of executed trades; and printing of reports. Moreover, the multi-IDB interface system may provide additional security and reliability mechanisms including issuance and processing of security (certificates), full or partial system scalability, server redundancy (for load balancing and reliability) as well as programmable function keys.

### BRIEF DESCRIPTION OF THE DRAWINGS

The benefits of the present invention will be readily appreciated and understood from consideration of the following detailed description of the exemplary embodiments of this invention, when taken with the accompanying drawings, in which same numbered elements are identical and:

FIG. 1 illustrates one implementation of a multi-IDB interface system designed in accordance with an exemplary embodiment of the invention;

FIG. 2 illustrates a GUI that is provided by or included in the interface incorporated in the multi-IDB interface system designed in accordance with an exemplary embodiment of the invention;

FIG. 3 illustrates an example of an expanded price matrix view;

FIG. 4 illustrates an example of a monitor view included in the GUI illustrated in FIG. 2;

FIG. 5 corresponds to the example of the blotter view illustrated in FIG. 2;

FIG. 6 illustrates a multi-IDB interface system designed in accordance with an exemplary embodiment of the invention;

FIG. 7 is an exemplary diagram used to describe an ASP deployment option for deploying components of a multi-IDB interface system designed in accordance with an exemplary embodiment of the invention;

FIG. 8 is an exemplary diagram used to describe an full-software deployment option for deploying components of a multi-IDB interface system designed in accordance with an exemplary embodiment of the invention;

FIG. 9 is an exemplary diagram used to describe a deployment option for deploying components of a multi-IDB interface system, which re-routes IDB connections, designed in accordance with an exemplary embodiment of the invention;

FIG. 10 illustrates one example of such a preferences screen used during user or dealer profile initialization or profile modification in accordance with an exemplary embodiment of the invention;

FIG. 11 illustrates one exemplary configuration of a blotter preferences category tab designed in accordance with an exemplary embodiment of the invention;

FIG. 12 illustrates a JTIWeb framework that may be used within the architecture illustrated in FIG. 6;

FIG. 13 illustrates a middle tier server illustrated in FIG. 12 using a class diagram overview;

FIG. 14 is a sequence diagram illustrating one implementation of an order entry process in accordance with an exemplary embodiment of the invention;

FIG. 15 is a structural diagram of one configuration of exemplary components involved in providing a trade feed function;

FIG. 16 is a UML sequence diagram of a first IDB trading process shown in FIG. 15;

FIG. 17 is a structural representation of an exemplary configuration of the components involved in market feeds;

FIG. 18 illustrates an exemplary implementation of a process for providing a market feed functionality in accordance with an exemplary embodiment of the invention by a UML sequence diagram;

FIG. 19 illustrates an exemplary implementation of a login procedure for a user logging into a multi-IDB interface system designed in accordance with an exemplary embodiment of the invention;

FIG. 20 illustrates one implementation of a database schema that may include a plurality of sub-databases in the persistence storage device illustrated in FIG. 6;

FIG. 21 illustrates one example of an IDB API wrapper used in an exemplary embodiment of the invention;

FIG. 22 illustrates an operation flow of a client application, which uses a third IDB API architecture in accordance with an exemplary embodiment of the invention;

FIG. 23 illustrates a GUI that may be used to perform multi-IDB interface system administration in accordance with the exemplary embodiments of the invention; and

FIG. 24 shows an exemplary configuration of a detail screen associated with the administration tool GUI illustrated in FIG. 23.

### DETAILED DESCRIPTION OF EXEMPLARY EMBODIMENTS

As the fixed income product market business becomes more electronic, speed of execution and consolidated information is a competitive advantage. However, routinely each IDB has its own proprietary electronic trading system. Users working for dealers need to use these electronic trading systems to stay competitive, both in terms of speed of execution and for managing commissions. Additionally, IDBs conventionally offer discounts to trade on these systems instead of voice-implemented trading.

Conventionally, each one of these electronic trading systems has a proprietary Graphical User Interface (GUI) for display to the users and a proprietary Application Programming Interface (API) for use by the dealer development staff to allow the dealer trading system to interact with data, e.g., receive and display pricing information contained in a data feed provided by the IDB and place orders with the IDB.

To be effective, users, e.g., dealer representatives such as traders, sales personnel and dealer administrators, must learn how to operate and navigate many electronic trading systems. Moreover, users are forced to display multiple GUIs, for example, on a single monitor, on multiple computers or computer monitors, to simultaneously run multiple electronic trading systems. As a result, valuable screen real estate is exhausted to display market information from multiple IDBs. Even if a user is able to simultaneously run multiple electronic trading systems, it is very difficult for users to monitor multiple electronic trading systems and act upon the information provided by these systems in a timely manner.

Accordingly, the exemplary embodiments of the invention may be implemented to provide a multi-IDB interface system (and components thereof) and processes that enable users to trade for financial instruments with multiple IDBs through a single user interface. Additionally, exemplary embodiments of the invention may provide a multi-IDB interface system (and components thereof) and processes for outputting and inputting data related to financial instruments markets, for example, the global fixed income securities market. More specifically, the exemplary embodiments of the invention provide users with an interface that enables consolidation of bids and offers from multiple electronic trading platforms and allows users to enter transactions to multiple IDBs from a single GUI.

Such a multi-IDB interface system may be of considerable use to, for example, representatives of the dealer community, e.g., which includes, for example, a top tier of twenty-six primary dealers, a second tier of dealers of approximately eighty professional trading houses, mid-sized banks, regional dealers, and a third tier of fixed income players made up of one hundred and twenty small sell-side firms. Users may also include members of international markets and clients.

The exemplary embodiments of the invention provide a utility that may occupy a desktop and provide a “best of breed” format with a consolidated view of the entire electronic market for bonds. This format may be beneficially utilized by, for example, dealers and buy-side firms in the United States and internationally. The exemplary embodiments of the invention may be used to facilitate access to Treasury bonds and U.S. fixed income securities, European and Asian bonds, as well as other securities, such as futures.

Multi-IDB interface systems designed in accordance with the exemplary embodiments of the invention provide a consolidated platform for interfacing with the growing number of electronic trading systems for financial instruments markets. The consolidated platform may be designed to provide a fully secure and scalable environment that is simple to install and easy to integrate with in-house systems. In one implementation, a client application component of the multi-IDB interface system (explained in detail below) may reside on any existing work station. Installation and upgrades may be accomplished within seconds by downloading client application software from a system server.

Exemplary embodiments of the invention are platform independent. As a result, the system, system components and methods may be used to aggregate data from multiple IDB data feeds and to provide that data on various dealer computer systems. Thus, the multi-IDB interface system and system components designed in accordance with the exemplary embodiments of the invention may be used on any one of many different platforms used by a dealer. Such platform independency is beneficial because each platform provides a different API for different system services. Thus, conventionally, a PC program must be written to run on the Windows platform and then again to run on the Macintosh platform. Such is not the case with the present invention, as the various embodiments of the invention have been designed to be platform independent.

Additionally, the exemplary embodiments of the invention enable both IDBs and dealers to save on resources that would otherwise be deployed to develop in-house aggregation solutions.

The exemplary embodiments of the invention also provide users with an interface that assists them in viewing the best prices on one screen across multiple IDB data feeds. This supports optimization of trading decisions by routing orders to the IDB chosen by the user for trade execution. It should be appreciated that each IDB has at least one associated IDB feed, an API, user interface (conceptually thought of as front end) and a back end (conceptually thought of as a broker component).

In accordance with the exemplary embodiments of the invention, a multi-IDB interface system (and system components) and method may consolidate bid and offer price and quantity data across multiple IDBs. The system and method allow the users to view the best prices on one screen with ease of interaction with all the IDBs. Furthermore, users are able to enter transactions to any or all of the IDBs from a single screen.

The multi-IDB interface system may be implemented with any and all platforms that exist on a user's desktop and can be easily integrated with other front and back office systems associated with the dealer. The multi-IDB interface system may cooperate with other systems in a dealer's front office such as risk and profit and loss systems, as well as with the back office system for STP. The multi-IDB interface systems may also replace proprietary IDB systems that are conventionally installed on user desktops for use with IDB data feeds.

A multi-IDB interface system designed in accordance with the exemplary embodiments of the invention includes three major functional components: a system engine, a FIX engine and a data storage device (which may be implemented as one or more storage devices). The system engine manages connectivity to the IDB systems and the dealer systems. The architecture behind the system engine provides dealers with the access through which connectivity is maintained to the IDBs' systems as well as to the dealers' front office systems. The FIX engine provides the connectivity maintained between the multi-IDB interface system and the dealers' back office systems. Communication with the IDBs, both from and to them, is managed through IDB proprietary APIs. Data feeds from multiple IDBs may be translated into a common interface readable by the multi-IDB interface system.

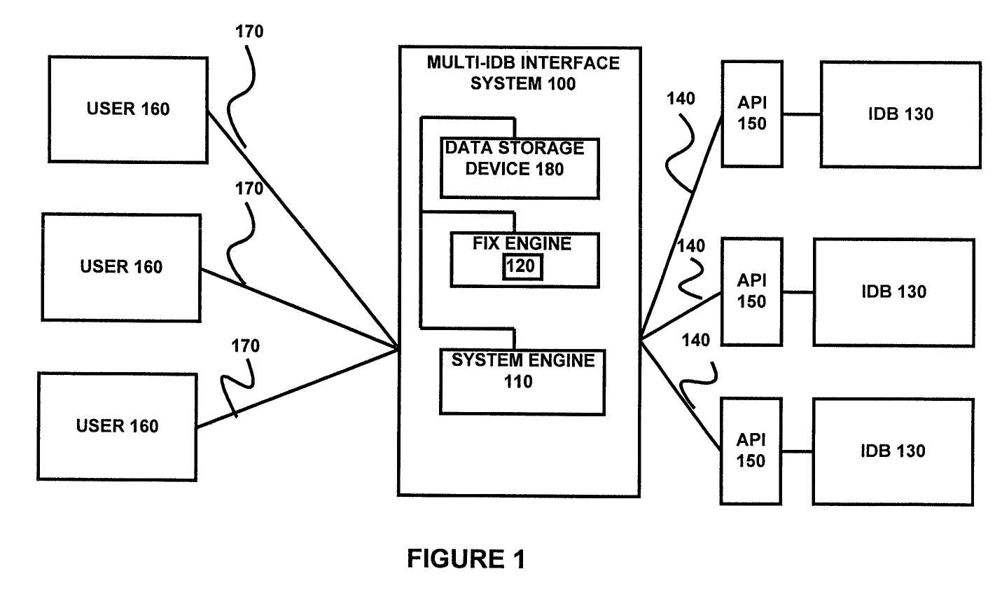

FIG. 1 illustrates one implementation of a multi-IDB interface system 100 designed in accordance with an exemplary embodiment of the invention. As mentioned above and shown in FIG. 1, the system 100 has three major functional components: a system engine 110, a FIX engine 120 and a data storage device 180. The cooperation of system engine 110 and the storage device 180 consolidates all the data received from the IDBs 130 via the feeds 140 and IDB specific APIs 150 and then selectively provides that data to the user 160 using the system engine 110 via a plurality of links 170.

The system engine 110 may be implemented as an application that coordinates the sorting and display of the data provided via the IDB feeds 140. The system engine 110 is dynamic in that its operation and instructions for operation in connection with a particular user 160 may be specific to that user 160. For example, the system engine 110 may be altered to accommodate for a user's subscription to or cancellation of a subscription to data from a particular IDB 130 (as indicated in, for example, a user profile stored in the data storage device 180).

As a result, a user 160 (or the dealer employing the user) may subscribe to receive data from a particular IDB; however, the development staff for that particular dealer does not need to work directly with this IDB to provide compatibility between the IDB API and the user's front and back office applications and systems. The cooperation of the system engine 110 and FIX engine 120 provide this compatibility with that particular IDB or any other IDB that is coupled to the system 100. Such a configuration has utility because, for example, dealers do not need to worry about changes implemented by IDBs, e.g., an IDB specific API change, because the system engine 110 may make any associated necessary changes. Since the system engine 110 is used to interact with all of the IDBs, the development staff of a dealer 160 only has to integrate with the single user interface 120 associated with the multi-IDB interface system 100 to pass data to and from front office applications and systems. Further, the FIX engine 120 cooperates with the system engine 110 to pass data to and from back office applications and systems.

The system engine 110 manages all users' client application connections and maintains a store of all orders, trades and user preferences in the data storage device 180 (explained in detail below). It also operates to ensure accurate routing of orders to the correct IDB. The system engine 110 also manages an inventory of financial instruments, e.g., securities, that a user is watching to ensure instantaneous updates from the IDBs 130. The system engine 110 supports STP processing to the dealer front office systems. The cooperation of the system engine 110 and the FIX engine 120 supports STP processing to the dealer back office systems.

The system engine 110 consolidates prices from multiple IDBs onto a single GUI for viewing and execution making it much easier for a user to identify the best available price and allowing him/her to send orders to multiple IDBs with a single click. Users can customize the way in which the system engine 110 interacts with them in various ways by providing information about their particular preferences using user preferences tabs, explained in detail below. For example, the system engine 110 interaction may be customizable so that a user can set the priority of execution on hits/lifts as well as preferred order routing. Additionally, the customization of the system engine 110 interaction can be overridden in real time by the user 160. The GUI supported by the system engine 110 may also include a save option that allows a user 160 to save his desktop data explicitly. Alternatively, or in addition the user 160 may be presented with the option to save the desktop when the user logs out of the system 100.

The system engine 110 may be built using, for example, a Swing Component Library (which is part of Java) where available. These lightweight components may be preferable to heavyweight Abstract Window Toolkit (AWT) components for a number of reasons including more efficient use of system resources and improved features.

The FIX engine 120 may, for example, issue trade tickets to clients' back office applications and systems to allow dealers to record trades into their own back office administration or management systems.

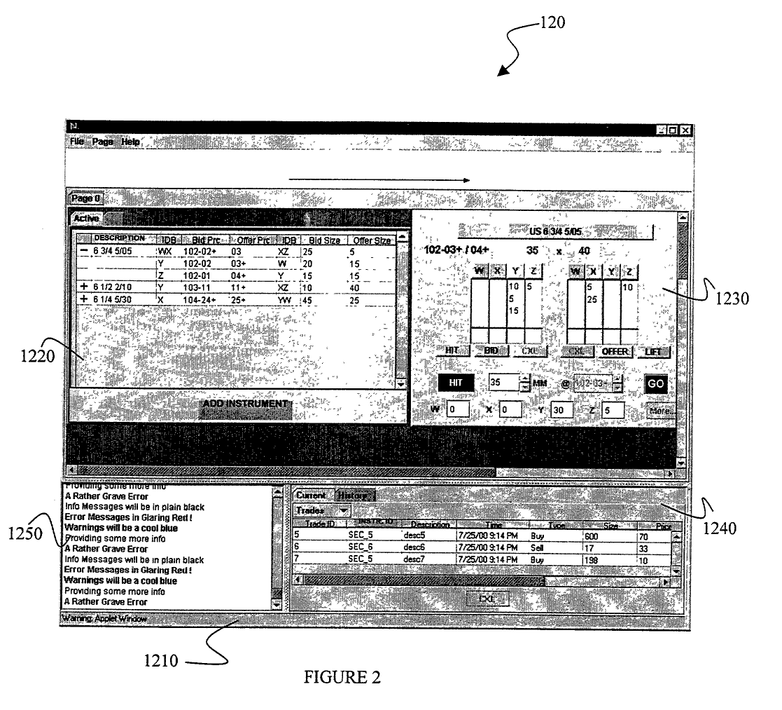

As mentioned above, the system engine 110 may support a GUI 1210, an example of which being shown in FIG. 2. The GUI 1210 is a single user interface that shows the consolidated IDB prices. The GUI 1210 may be configured to allow for single keystroke execution of trades. Moreover, GUI 1210 may be configured so that a single screen is displayed for a particular type of product, e.g., a specific financial instrument such as Treasuries. The GUI 1210 may be customizable to a particular user or to a particular dealer employing one or more users. Therefore, the implementation illustrated in FIG. 2 is merely an example.

As shown in FIG. 2, the GUI 1210 may include several components including, for example, a price matrix view 1220, monitor view 1230, blotter view 1240 and message view 1250.

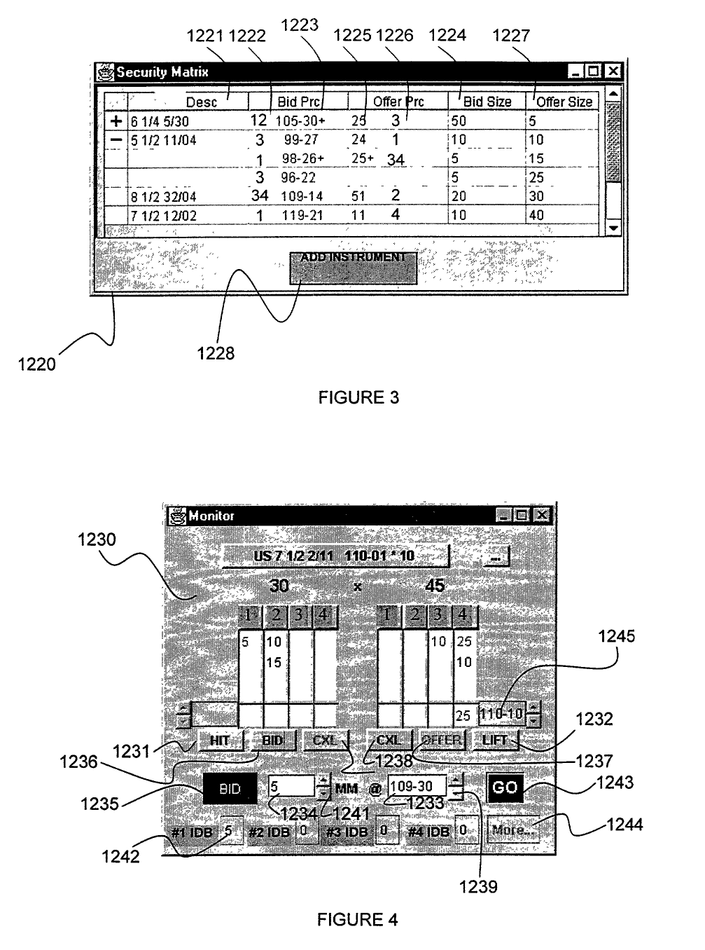

FIG. 3 corresponds to the example of the price matrix view 1220 illustrated in FIG. 2 but with a slightly different exemplary configuration of the price and IDB fields. The price matrix view 1220 may include, for example, a matrix that is a table, which, in structure, is similar to a spreadsheet. The rows within the table may include data identifying a particular financial instrument 1221, the particular IDBs 1222 seeking that financial instrument (and the associated bid price 1223 and bid size 1224), the particular IDBs 1225 offering that financial instrument (and the associated offer price 1226 and offer size 1227). The rows included in the table of the price matrix view 1220 may be configured to include additional information, e.g., a bid yield and/or offer yield for a particular financial instrument. The actual rows that are shown may be determined by the unique financial instruments that the user has chosen to display (e.g., by selecting them for display in the user's service profile). Additionally, columns can be sized according to a user's preference.

Moreover, the price matrix view 1220 may be configured to indicate the best bid/offer for a particular financial instrument. More specifically, as shown in FIG. 3, the first row has a plus “+” sign, followed by a row with a minus “−” sign and four rows with no sign at all. The table of the price matrix view 1220 may be configured such that the table can be expanded to display additional information about a particular financial instrument. For example, the row including the plus “+” sign displays the best bid/offer for a particular financial instrument and is expandable to show other bids and/or offers from IDBs for that particular financial instrument, e.g., other bids and/or offers below the market. The row with the minus “−” sign is a row that has been expanded, and the rows with no signs correspond to the additional bids and/or offers for that particular financial instrument. Further information about the expanded row in the price matrix view 1220 may be provided in the monitor view 1230 when a user selects a particular financial instrument by clicking on its corresponding row, as explained below.

In the price matrix view 1220, additional financial instruments, e.g., securities, may be added by clicking on the add financial instrument graphic 1228, which may initiate display of a list of financial instrument categories from which a user may select. A list of the financial instruments for trading on the multi-IDB interface system may organized, for example alphabetically, in categories, e.g., first by product, then by sector, or in any other way that would be useful to a user, e.g., organized into categories such as, for example, actives, bills, or by maturity (0-1,1-2, 2-5, 5-15, 15-30). When the user interface 1210 is first opened, the user may see only the categories of financial instruments. The user may then select, or click on, the category to expand the listing and view the financial instruments in a particular category. The user can select a financial instrument by clicking on it, which may expand the row and/or highlight the row.

As a result of adding a new financial instrument the price matrix includes an additional row including the plus “+” sign. Such a selection may cause a subscription to that financial instrument market, which would allow the user to view information on that financial instrument market from the IDBs to which the user has access.

In the matrix view 1220, a row may be selected by clicking on the row, and deleted, for example, by subsequently using the delete key on the keyboard. Further, it is foreseeable that function keys may be fully programmable on a system, dealer or user basis.

The bid price field 1223 may include the IDB identification field 1222 (e.g., “1” for the first IDB, “2” for the second IDB, “3” for the third IDB, etc.) that are, for example, the first four characters. The price format of the bid price field 1223 may be based on financial instrument. Both the bid price field 1223 and the offer price field 1226 may be displayed and incremented based on a financial instrument type, e.g., bills, may be displayed using the discount rate, and be incremented on a half point basis, notes may be displayed and incremented in quarters of 32nds with increments, bonds may be displayed and incremented in halves of 32nds, and financial instruments (when issued) may be displayed using yield and incremented on basis point.

The offer price field 1226 may include the IDB identification field 1225(e.g., “1” for the first IDB, “2” for the second IDB, “3” for the third IDB, etc.) that are, for example, the last four characters. If the price handle of the offer is the same as that in the bid price field 1223 then the price handle may not be displayed. The bid size field 1224 includes a consolidation of bid sizes for all equal prices. Within the bid size field 1224, different display colors may be used to indicate when the user or dealer viewing the view is part of the total bid size. The offer size field 1227 may include a consolidation of offer sizes for all equal prices. Within the offer size field 1227, different display colors may be used to indicate when the user or dealer viewing the view is part of the total offer size. If a bid yield field is included (not shown), that field indicates the calculated yield for a best bid price unless the price is in yield. If an offer yield field is included, that field indicates the calculated yield for a best offer price unless the price is in yield.

Also included in the GUI 1210, is the monitor view 1230, which works in cooperation with the price matrix view 1220 to display financial instrument market information. FIG. 4 corresponds to the example of the monitor view 1230 illustrated in FIG. 2 but with a slightly different exemplary configuration. The monitor view 1230 may be, for example, an interface through which users enter orders and execute trades with multiple IDBs. The monitor view 1230 may show market data from a plurality, for example, four, IDBs assuming that the dealer and/or the user have access rights to all of these IDBs. If a dealer or a user at that dealer does not have access to a particular IDB, the relevant IDB stack may be blank or grayed out to indicate inaccessibility. Financial instruments can be added to the monitor view 1230 by being dragged from the price matrix view 1220 or selected from a comprehensive financial instrument list, as explained above. The monitor view 1230 shows the best price and depth of market (stack), as well as the price and size of the user's own bid/offer below the market stack. More than one monitor view 1230 can be opened so that multiple financial instruments can be viewed simultaneously.

If the user or his/her dealer employer has bids or offers on the market, the user's or the dealer's sizes may be highlighted in different colors (in the market stack) as well. Various additional fields may be provided in connection with the monitor view 1230. For example, the monitor view 1230 may include a financial instrument field that may be clicked on to display a list of financial instruments for a user to select. Additionally, hit/lift graphics 1231, 1232 may be activated by a user to populate the price field 1233 and size field 1234 based on the market. The activation of these fields 1231, 1232 may also allocate the requested total size of an offer or bid to IDB text boxes 1242 based on a default priority. Clicking on the hit/lift graphics 1231, 1232 change labels indicated in the display 1235 to reflect an action of the user. The default action label in the display 1235 of the monitor view 1230 may be blank until, e.g., one of the hit/lift graphics 1231, 1232 is clicked.

A selected row corresponding to a financial instrument in the price matrix view 1220 may flash when a HIT indicator is received by the user's interaction with the monitor view 1230 to act upon data illustrated in the GUI 1210. Similarly, a selected row may flash when a LIFT indicator is received.

Clicking on or actuating the hit/lift graphics 1231, 1232 may also set focus, i.e., move a cursor or other indication of a focus, to the size field 1227, 1234. The hit/lift graphics 1231, 1232 can also be configured to display a warning message if there is a user's or dealer's own bid/offer on the market.

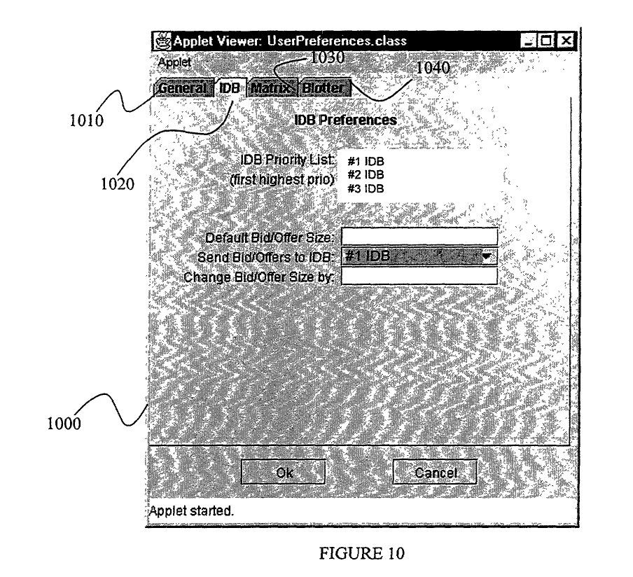

Similarly, activation of the bid or offer graphics 1236, 1237 populate the price field 1233 based on market and the size field 1234 based on a user's preferred bid/offer size, e.g., indicated in a user's service profile that may be set up during an initial login of a user or set up by an administrator and modified subsequently at the will of a user/administrator. Such a user's service profile is explained in more detail with reference to FIGS. 10, 11, 23 and 24. Activation of the bid/offer graphics 1236, 1237 may populate the user's preferred bid/offer IDB with the preferred size. If there is no market price available, the last trading price may be used for this population and the display of associated data. The bid/offer graphics 1236, 1237 also change the label displayed in the display 1235 to reflect a particular action. Activation of the bid/offer graphics 1236, 1237 also sets focus to the price field.

The monitor view 1230 may also include CXL graphics 1238 that, when activated by a user, e.g., by clicking on the graphic, may serve to cancel all of the user's bid/offer across IDBs on the specified financial instrument. The monitor view 1230 may also include price increment(+/−) graphics 1239 that allow a price to be changed up/down based on price increments for a specific financial instrument. The monitor view 1230 may also include size increment (+/−) graphics 1241 that allow a size of an offer or bid to be incremented up/down in millions based on a default or a customizable unit based on a user's individual choice indicated during user profile initialization or modification.

Fields may also show the size of the users' open bid/offer from each IDB, if any. Fields may also show the user's current bid/offer price (this may or may not be the same across all the IDBs). The price spinner 1245 may be used to change a users open bid/offer price across multiple IDBs with one click.

The view 1230 may also include IDB textboxes 1242 that may display information so that a user can determine which IDBs orders and trades are sent to. Following hit or lift action, the sizes of IDBs are populated based on the specified value in the size field 1234 and any default IDB priority, e.g., an order of preference of the IDBs based on, for example, a user 3 preference. Similarly, upon bid or offer actions, bid or offer size may be set to a user's preferred bid or offer size.

The monitor view 1230 may also include a GO graphic 1243, which, upon activation by a user, triggers various functions depending on the context. For example, if a hit or lift action is in progress, activation of the GO graphic 1243 may hit or lift the best bid for the amount specified in the size field 1234. The trade will then be routed to the IDBs for the sizes indicated in the IDB text boxes 1242. A trade will be created for the full amount an IDB is showing before the next IDB trade is created. If the size cannot be fulfilled based on what is being displayed then an error will be returned. Alternatively, if a hit or lift action is in progress, a bid or offer is sent to the specified IDB for the price and size shown. It should be appreciated that the GO graphic 1243 may turn insensitive because of a price change resulting from new information provided by the IDB feeds. If such an insensitivity occurs, a user may have to press the HIT graphic 1231 again to reactivate the sensitivity of the GO graphic 1243.

Additionally, a MORE graphic 1244 may be included in the monitor view 1230 that may be configured to allow the user to create more order routing rules.

The utility of the exemplary embodiments and the monitor view 1240 illustrated in FIG. 4 will now be explained in connection with the following examples.

### EXAMPLE 1

A user may click on the “HIT” graphic 1231 or press a function key, e.g., F1, which may change the display 1235 to include a “HIT” label, fill the size field 1234 with a value of thirty and the price field 1233 with 110-01. The first IDB and second IDB textboxes 1242 may be populated with, for example, 5 and 25 respectively. The user can then change the IDB size individually by editing the IDB text boxes 1242. Note that editing the IDB textboxes 1242 may cause an update on the size field 1234. For example, assume the first IDB has the highest priority. The user can overwrite the IDB priority and reduce first IDB size from 5 to 3 by entering 3 in the first IDB text box 1242. The total size in the size field 1234 may then be reduced to automatically. Clicking on the “GO” graphic 1243 may then send an order of 3MM to first IDB and an order of 25MM to the second IDB.

### EXAMPLE 2

A user may click on the “HIT” graphic 1231 or press a function key, e.g., F1, which may change the label 1235 to display “HIT”, fill the size field 1234 with 30 and the price field 1233 with 110-01. It may also populate the first IDB and second IDB textboxes 1242 with 5 and 25 respectively. The user may then change the size to 15MM (via graphics 1241), which may send a hit request to first IDB for 5MM and second IDB for 10MM. Note this example assumes first IDB has highest priority. Thus, in such a scenario, the second IDBs size may then be reduced first before reducing first IDB size. EXAMPLE 3

A user may click on the “BID” graphic 1236 or press a function key, e.g., F2, which may change the display 1235 to include the “BID” display, fill the size field 1234 with a user's preferred size, e.g., 5MM, and the price field 1233, e.g., 110-01. The user's preferred bid IDB may also be populated with his preferred size, e.g., 5MM. The user may then change the price up a “plus” unit increment using the “+” key of the +/− graphics 1239 and the size from 5MM to 8MM using the “+” key of the +/− graphics 1241. If the user wishes to send the bid to an IDB different from that specified in his preference setting, the user can do so by editing the IDB textboxes 1242. For example, the user can enter 8 in the third IDB text box and 0 in the second IDB text box and, then click on the “GO” graphic 1243. This transmission may send an offer to Instinet for 8MM at 110-01+. This may then change the overall market to a new best bid.

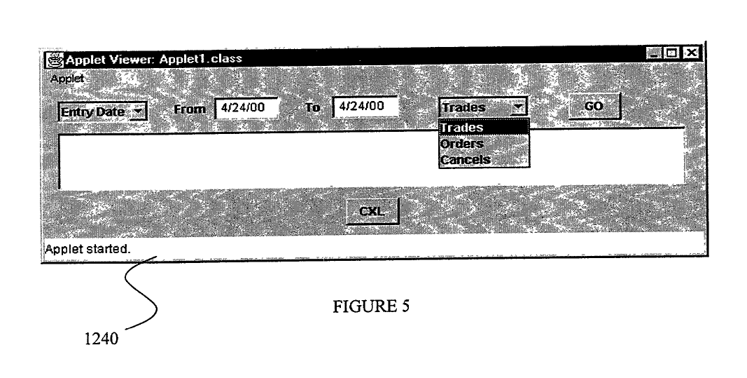

FIG. 5 corresponds to the example of the blotter view 1240 illustrated in FIG. 2 but with a slightly different configuration. As shown in FIG. 2, the blotter view 1240 may include information about a user's trades, e.g., trade identification data, financial instrument identification data, trade time, trade type, trade size, trade price, etc. As shown in FIG. 5, the blotter view 1240 also may display subsets of the user's trade history, e.g., the user's open orders, executed trades, and/or cancelled orders in real-time. Its format may be customized, such that columns (as illustrated in FIG. 2) can be selected, moved, and sorted according to user preference. For example, the columns in the blotter view 1240 (shown in FIG. 2) can be selected by the user from a selection list. The list of columns may be determined by the union of the IDB APIs. A user may have the ability to set the criteria for what to display. The blotter 1240 view may update in real time based on these criteria. A user may have multiple blotters views.

Order and cancellation data may include, for example, order identification data, financial instrument identification data, description data, order status data, IDB identification data, data indicating who created the order or cancellation, data indicating a creation time, data indicating who modified the order or cancellation, data indicating a modification time, data indicating order or cancellation type, data indicating order or cancellation size, price, amount remaining, comments, etc.

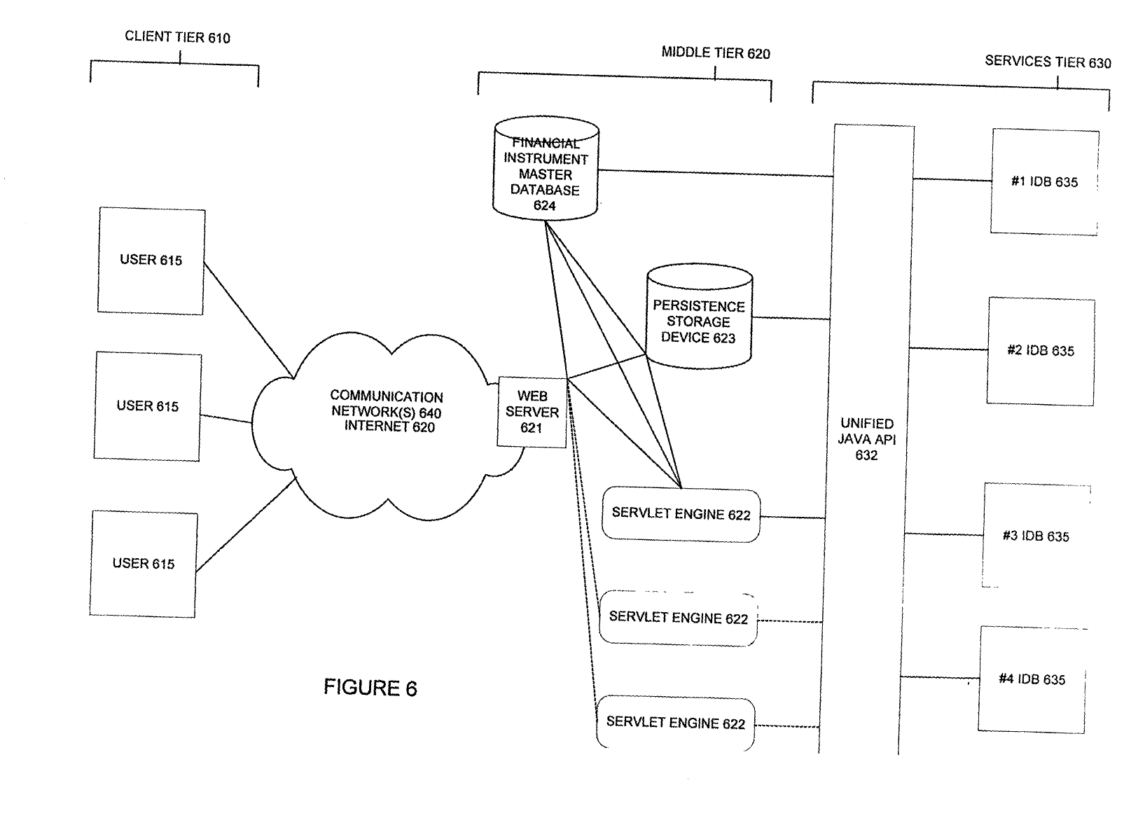

Order identification data may include numerical value codes that are generated by the multi-IDB interface system. The financial instrument identification data may include, for example Committee on Uniform Securities Identification Procedures (CUSIP) code, e.g., a number. The identification data may only be used for a particular IDB. The description data may include alphanumeric characters and may be used by the financial instrument master storage device (explained in more detail below in connection with FIG. 6) for administrative operations. The order status data may include a designation of a particular order's status, e.g., “new”, “filled”, etc. The IDB identification data may include an IDB name associated with an order, that is, the IDB source. The creator identification data may include a user name for the user who created the order. This creator identification data may be useful to an administrator or supervisor for determining who has created orders.

The creation time data may include a time such as a time stamp of when the system engine 110 sent the order to the associated IDB. The data indicating the modifier may include a user name that indicates who last changed the order. It is foreseeable that the data indicating the modifier may be modified or cancelled by a system administrator. The data indicating modification time may include some indication of time of last modification to the order. The type data may include indicia of whether the order is a buy, sell, bid, or offer order. The size data may include indicia of the size of a particular order. The price data may include indicia of the price of a particular product, e.g., bond, associated with the order. The data indicating what is remaining may include an indication of the remaining size available by partial fills. The data indicating additional comments may include any additional comments and may include alphanumeric characters.

Trade data may include, for example, trade identification data, financial instrument identification data, description data, data indicating when a trade was created, data indicating the type of trade, trade size data, price data, data related to trade settlement, data indicating any type of commission associated with the trade, comments, etc.

Trade identification data may include values that are numbers and are generated by the multi-IDB interface system. The financial instrument identification data may include, for example, a CUSIP code word or other indicia of a particular financial instrument. The description data may include alphanumeric characters and may be used by the financial instrument master storage device (explained in more detail below with reference to FIG. 6) for administrative operations. The creation time data may include a time such as a time stamp of when the system engine 110 sent the trade to the associated IDB. The type data may include indicia of whether the order is a buy, sell, bid, or offer order. The size data may include indicia of the size of a particular order. The price data may include indicia of the price of a particular product, e.g., bond, associated with the order. The settlement data may include an indication of particular terms for settlement. The commission data may include information related to who gets a commission from the order and for what amount. The data indicating additional comments may include any additional comments and may include alphanumeric characters.

The message view 1250 illustrated in FIG. 2 may display status messages, as well as additional data feeds, such as market analytics from the IDBs and the system engine 110. The message view 1250 may be, for example, a scrolling view to display messages received from one or more IDBs, a system administrator, etc. Messages may be displayed, for example, in time sequence. Additionally, there may be a source indicator on each message to identify the source of the message, e.g., particular IDBs, a system administrator, etc. It is foreseeable that all general messages may be displayed in the message log view as well as any financial instrument specific messages based on the user's subscription list stored in his/her user profile. It is foreseeable that no confirmations may be necessary for user trading. It may be preferable, e.g., when speed is an important consideration, that a user would have to use as few as possible key strokes or mouse clicks for trading operations.

The GUI may use specific key functions associated with specific components of the multi-IDB interface system. For example, within the monitor view 1240, e.g., for the price field 1233 and the size field 1234, the plus or minus graphics 1239, 1241 or the plus and/or minus keys on a key board may be used, e.g., selected by a user clicking on the graphic, in order to increase/decrease a value indicated in that field. Similarly, in the monitor view 1230, the “GO” graphic 1243 or the “Enter” key on the key board may be used, e.g., selected by a user clicking on the graphic, to execute a specific action, e.g., trade, order submission, etc.

According to the exemplary embodiments of the invention, the multi-IDB interface system architecture is designed around protocols, technologies, and products that provide necessary security requirements, system responsiveness and robustness. As mentioned above, one such protocol may be FIX as utilized by the FIX engine 120 as illustrated in FIG. 1. FIX is an open standard developed by Soloman and Fidelity, for equities, as a mechanism for dealer to communicate with each other. Conventionally, the FIX protocol provides STP; however, after the trade is executed, the dealer must still record the trade into their own back office administration or management system. According to at least one exemplary embodiment of the invention, dealers may hook up their back office applications to the multi-IDB interface system 100 using the FIX engine 120 because FIX is an open protocol. Such a configuration may have increased utility because, for example, it is easy to integrate with existing systems and applications by using an open API (e.g., FIX). As a result, the exemplary embodiments of the invention may use the FIX protocol, for example, in the FIX engine 120 illustrated in FIG. 1, and the system engine 110 for real-time exchange of transactions, enabling a single API connection to brokerage front-office and back-end systems.

The multi-IDB interface system architecture may be implemented using Java™ for multi-platform use or any other programming language. One implication of the use of Java™ for the system is that it ensures the portability of the platform so that a client application component of the software can be executed on any existing user work station. Installation may be accomplished within seconds by downloading the client application software from a system server. Similarly, upgrading may be simple and transparent, as the new client application software may be automatically downloaded to a terminal when the user logs into the multi-IDB interface system. Simultaneous multiple logins for an individual user may not be allowed.

The multi-IDB interface system may be built on an existing framework developed to facilitate electronic trading over networks and employ widely used, reliable components including Sun™ Microsystems servers and the Oracle™ Relational Database. The system may use an Oracle™ database to store all information including persistence and database tables.

To provide a fully secure and scalable solution, the exemplary embodiments may utilize Sun™ Microsystems server technology. Such technology may provide flexibility to scale processing needs as a user base grows and throughput demands increase. The exemplary embodiments of the invention may also utilize an Oracle™ 8i relational database platform that provides high reliability, scalability, speed of execution, and data security. A system designed in accordance with an exemplary embodiment of the invention may provide a networked environment and modular design demand robust communication and reliable message delivery.

FIG. 6 illustrates, in a conceptually different way, a multi-IDB interface system designed in accordance with an exemplary embodiment. As illustrated in FIG. 6, the multi-IDB interface system 600 may include a client tier 610, a middle tier 620 and a services tier 630. The client tier 610, also known as the front end or client layer, handles all user interactions. The client tier 610 may include, for example, a Java applet running in a web browser. The Java applet can display the information requested by the user, and may have the ability to update views dynamically. The client tier 610 may communicate with the middle tier 620 using, for example, the standard HTTP protocol to work seamlessly through firewalls.

The Java-applet implemented client application may be designed using, for example, Model-View-Controller (MVC), which is a design pattern that emphasizes a separation between data and the presentation of the data. According to MVC, the data may be considered the “model.” The model may include merely data, with no information on how it is to be displayed. The “view” may be a presentation of the data, and the “controller” may allow the user to change the contents of the model, or change the view into the model. One benefit of an MVC design is that multiple views can be written to display the same data in the model in different ways.

The middle tier 620 may include a web server 621, at least one Java servlet engine 622 (corresponding to the system engine 110 and the FIX engine 120 illustrated in FIG. 1), a persistent storage device 623 and a financial instrument master storage device 624 (both included in the data storage device 180 illustrated in FIG. 1).

To allow the system to operate seamless through dealer firewalls, all communication between the applications used at the client tier 610 and the middle tier 620 may take place over HTTP via, for example, a public and/or private communication network 640 (which may be or include the Internet and/or various extranets associated with one or more users and/or dealers) using the web server 621. Additionally, security mechanisms may be used in combination with this communication network 640 access to provide improved transaction confidence. For example, Secure Socket Layer (SSL) encryption may be built into the system framework to ensure data integrity and provide secure transmission between the client application and servlet engine 622. Users may connect to the servlet engine 622 through either the Internet or a dedicated private connection. The web server 621 may be, for example, an Apache (version 1.3.12) web server.

It should be appreciated that HTTP is a request-response protocol, where the user must initiate all connections. Nevertheless, functional requirements of the multi-IDB interface system 600 may require a technique known as “server push”, i.e., servers (e.g., servlet engines, distributing real-time status updates, e.g., IDB feed data to interested users. However, HTTP does not allow servers to initiate a transaction with a client, or user, (e.g., pushing data out to it). Thus, when the middle tier 620, for example, receives a status change it cannot open a connection to notify the client tier, or user, of the new data.

This obstacle may be overcome, for example, by utilizing a specialized framework, e.g., Random Walk's JTIWeb framework. The framework can achieve a server push technique by, for example, using multiple connections between the Java applet-implemented client tier 610 and a Java servlet implemented middle tier 620. When a user enters the multi-IDB interface system 600 via the client tier 610, the servlet engine 622 sets up session information for that user's connection but does not send back a response. As a result, the servlet engine 622 establishes a “persistent” connection back to the user.

Subsequently, the user may make various requests, for example, submitting an order, subscribing to market data, etc. These requests may be sent using new HTTP connections. Upon receiving a new request, the servlet engine 622 can look up information about the user making the request from the persistent storage device 623 and retrieve the connection back to the user that is still open. As results (e.g., market data, status updates, etc.) are received, they are flushed across that original persistent connection, and the connection is still never allowed to close.

There is a risk associated with this approach, which involves maintaining an open HTTP connection for potentially long periods of time. The communication network 640 may be or include the Internet, which includes various proxy servers that a connection travels through; these proxy servers do not expect long-standing open connections. Therefore, may arbitrarily close the connection. Thus, the servlet engine 622 and/or the Java applet implemented client tier application may actively monitor that the connection has not been lost. This is achieved by the transmission of regular “heartbeat” messages from the Java applet implemented client applications at the work stations or trading desks of the users 615 to the servlet engine 622 at specified time intervals. If the connection is closed, a client application may automatically log in again, reestablishing a connection between the applications of the users 615 and the servlet engine 622.

More than one Java servlet engine 622 may be used to provide scalability and load balancing within the system 600. The servlet engine 622 may be, for example, New Atlanta's ServletExec 2.2. The servlet engine 622 may include the business logic required to handle requests from the client tier 610, maintain user-specific state data in the persistent storage device 623, collect information from various data sources, e.g. IDB API's and send information back to the client tier 610.

The persistent storage device 623 may be implemented, for example, as a database, e.g., an Oracle™ relational database.

The financial instrument master storage device 624 illustrated in FIG. 6 holds information about all the known financial instruments, e.g., securities. The financial instrument master storage device 624 may also hold information indicating to which group a financial instrument (e.g., securities, securities from agencies, US treasury bills, etc.) belongs. The financial instrument master storage device may be maintained using a tool or straight SQL.

The services tier 630 may include the various IDB services 635 used by the multi-IDB interface system. Each of the different IDB APIs 635 work in cooperation with components of the middle tier 620 so that client applications in the client tier 610 can access their services. The APIs 635 may vary in terms of how they work, the platform they run on and which programming language they support. Systems designed in accordance with the exemplary embodiments of the invention may provide, for example, a unified Java API 632 into the various IDBs. The unified Java API 632 may be made available on the network using Tibco Rendezvous as a transport mechanism.

Tibco's Rendezvous is a publish subscribe middleware framework which enables creation of distributed systems. Rendezvous is the messaging system that is the foundation of TIBCO ActiveEnterprise, a line of e-business infrastructure products. Rendezvous is rapidly emerging as one protocol for enabling real-time messaging. Rendezvous provides a high-performance, scalable platform and enables the creation of robust event-driven applications. Rendezvous is a messaging software that delivers real-time publish/subscribe and request/reply messaging. It also supports qualities of service ranging from lightweight informational messages to certified and transactional delivery.

Rendezvous utilizes a distributed architecture to eliminate bottlenecks and single points of failure. Applications can select from several qualities of service including reliable, certified and transactional, as appropriate for each interaction. Messaging can be request/reply or publish/subscribe, synchronous or asynchronous, locally delivered or sent via WAN or the Internet. Rendezvous messages are self-describing and platform independent, with a user-extensible type system that provides support for data formats such as XML. Rendezvous APIs are available in Java, C, C++, Perl and COM.

Rendezvous' reliable delivery protocols implement fast and efficient delivery of messages under normal operating conditions. When applications send messages using Rendezvous, a daemon runs on the sending and receiving machines. The daemon is responsible for breaking messages down into packets on the sender side and re-assembling them on the receiver side.

Rendezvous makes it possible build redundant and fault tolerant systems. Messages sent to users Rendezvous may be serialized Java objects. As a result of using the Rendezvous framework, IDB messages may be converted to system message objects, which may be used internally in the multi-IDB interface system.

The multi-IDB interface system need not require any specialized hardware installation at a dealer's premises. This is because various components of the multi-IDB interface systems may be implemented as a software solution that provides a consolidation of bids and offers access to multiple IDB data feeds on a single user interface. This application may be a Java applet, and as such, the system may be downloaded or deployed over the Internet to the user's browser when the user navigates to an appropriate web site. This single user interface may provide the user with a consolidated view of multiple IDBs' data showing the current best bids and offers as well as the depth of the market. Furthermore, the exemplary embodiments of the invention may enable users to enter into transactions, e.g., trades, with any of the IDBs via use of the single user interface.

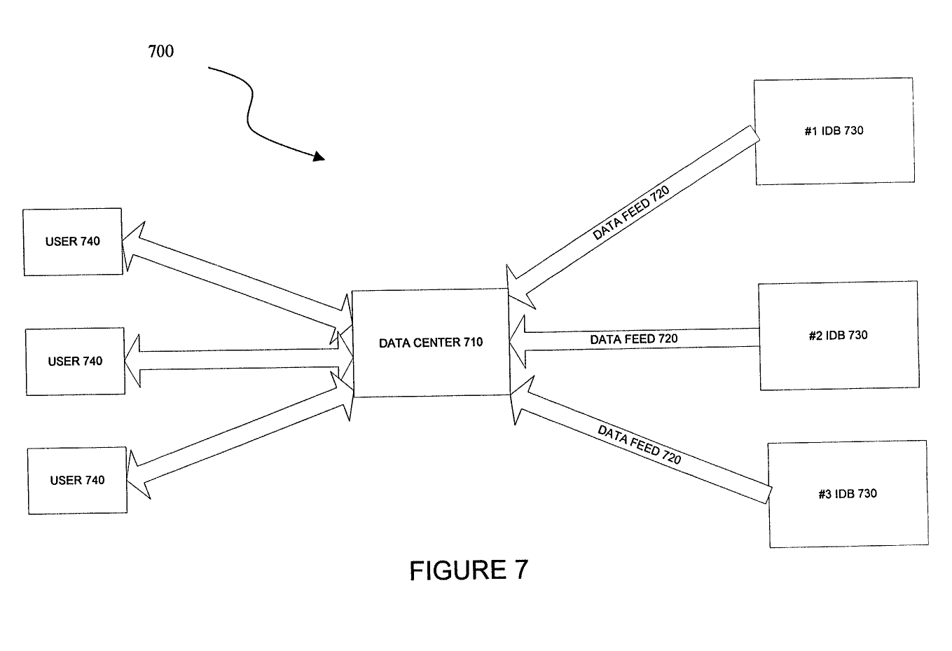

The multi-IDB interface system and its components may be deployed or delivered to users in any number of ways including an Application Service Provider (ASP) paradigm, a full software deployment paradigm, a data center integration paradigm, a hybrid paradigm approach that utilizes the first three paradigms, or any other process model that would provide the requisite efficiency, security and reliability. However, as illustrated in FIG. 7, the ASP deployment option may be the most efficient method of deployment. In the ASP model, the multi-IDB interface system 700 maintains a data center 710 with data feeds 720 coming from multiple IDBs 730. The data center 710 may be linked to users 740 via secure Internet connections (which may utilize wired and/or wireless connections) or through a dedicated private network. The data center 710 may communicate with the IDBs 730 using communication links (not shown) to communicate orders to the IDBs. The data center 710 may be implemented with redundant application and database servers operating at a remote data center location. Additionally, path redundancy may be incorporated into the private network and Internet connections. It is foreseeable that, to access the system, users may have to login to the data center with a dealer identification code, user identification code and/or password code.

Such a deployment implementation may offer significant advantages because new versions of a client application may be automatically applied to all users without having to distribute installation diskettes, etc. However, such an implementation also means that it may take a certain amount of time to download the application. Therefore, there may be added utility from maintaining the size of the application as small as possible. The system may provide a smaller client application (of the client tier 610 illustrated in FIG. 6) by keeping as much of the business logic as possible in the middle tier 620 illustrated in FIG. 6 (that is resident in the data center 710 illustrated in FIG. 7).

As a result, the client application may contain only display logic and as little else as possible. The application may also use standard compression technology (e.g., a Java Archive), to further reduce the download time. As an applet, the application can be deployed via any browser that can access the Internet and that contains a Java Plug-in. Java applets also provide robust security for Internet applications and object oriented architectural qualities with scalability for complexity and added functionality.

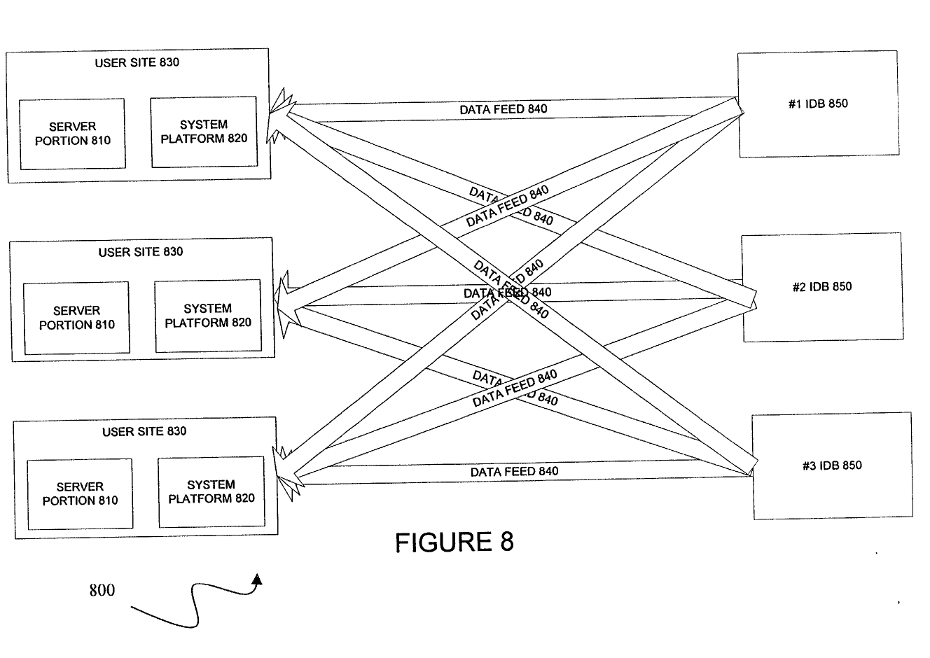

Alternatively, as illustrated in FIG. 8, the multi-IDB interface system 800 may be deployed via a full software deployment (e.g., site license). In such a method of system deployment, a server portion 810 of a system platform 820 may be installed at a dealer or user site 830 (for example, in a Local Area Network) with input from data feeds 840 that already exist at the site 830 from IDBs 850. Further, the client application program may be stored as media on a memory device including RAM, ROM, disks, CD ROMs, ASICs, external RAM, external ROM and the like at a user's work station or desktop.

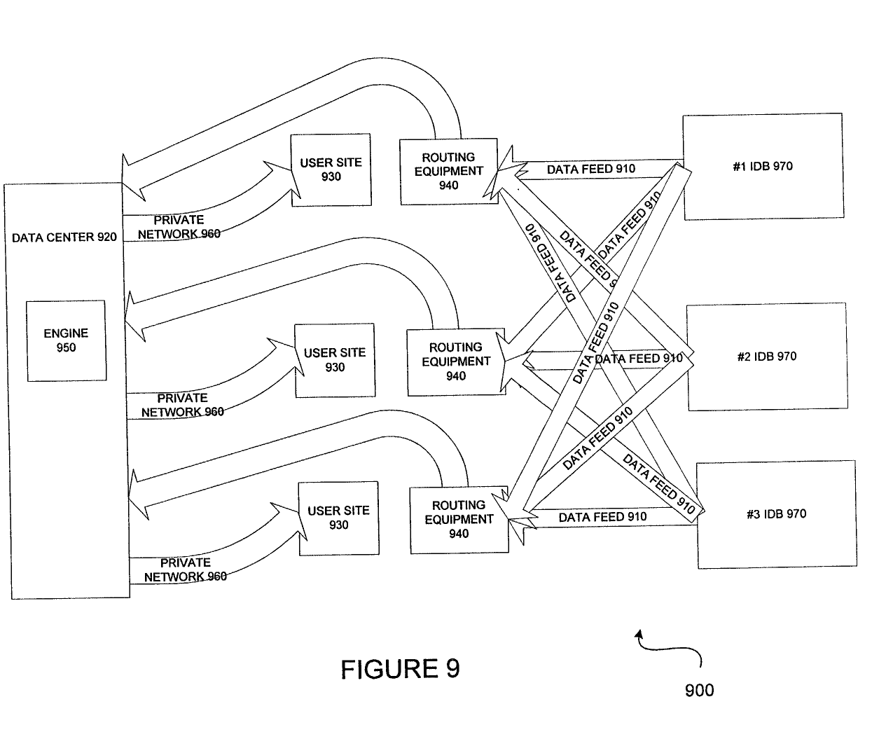

As illustrated in FIG. 9, a third approach to deploying the multi-interface system 900 is to re-route existing user IDB connections 915 to the data center 920 and back to the user's site 930 using re-routing equipment 940, which may be implemented using, e.g., routers. In such a scenario for deploying the system 900, the engine 950 (incorporating or implementing the system engine 110 and the FIX engine 120 illustrated in FIG. 1) in the data center 920 may be operated and connected to user sites 930 through a private network 960 (which may be specific to each or all of the user sites 930). Routing may be set up so that the engine 950 can interface with user's IDB connections 910 to the IDBs 970. Therefore, there may be no need for software installation or updates at the user site 930, although there may be requirements for additional network management.

A fourth approach may capitalize on the first three because different deployment paradigms will likely be required for different users. Depending upon user requirements, there can be hybrid versions combining the concepts of the above-describe paradigms.

As mentioned above, a user may customize the GUI 1210 to function in a manner that is conducive with his/her preferences included in a user profile. This user profile may include information generated by a user's actions during a profile initialization occurring following deployment of the multi-IDB interface system. Alternatively, depending on dealer preferences, user profiles may be set up during a dealer profile initialization that provides preferences, or default preferences for each of the users associated with that dealer.

It should be appreciated that each of the system components illustrated in FIGS. 7-9 illustrate only the IDB feed data flow and do not include components or links that illustrate the flow of data from a user to data center or IDB. Nevertheless, it should be appreciated that the users and user sites communication may occur among the users/user sites, the data center, its constituent engine(s) and the IDBs.

Regardless, during this profile initialization (or during any subsequent profile modification), a preferences screen may be generated by the multi-interface system to allow a user (or dealer system administrator) to input data regarding order and trading preferences. FIG. 10 illustrates one example of such a preferences screen. The preferences screen 1000 may include, for example, a tabbed pane with tabs including “General” 1010, “IDB” 1020, “Matrix” 1030, and “Blotter” 1040 categories. Each tab, when selected, may allow a user (or dealer system administrator) to review and input data related to preference information corresponding to each of the tabbed categories.

The “General” preference category 1010 may include preferences related to function keys, fonts (e.g., small, medium or large), language, etc.

As shown in FIG. 10, the IDB preferences category and its associated tab 1020 (which has been selected and is displayed), may include preferences that allow a user to set an IDBs priority list for HIT/LIFT operations with the IDBs. For example, a user may formulate bids and offers to be sent by utilizing default preferred bid/offer size as well as increment units of bid/offer size. A user may set relative IDB priorities, default bid and offer sizes, bid and offer routing information and information indicating how much bid and offer sizes should be changed using the graphics 1239, 1241 illustrated in FIG. 2.

It is foreseeable that there may be no system defaults or dealer-specific defaults for the IDB preferences. Therefore, a user may set them the first time he/she logs into the multi-IDB interface system. Alternatively, it is foreseeable that defaults for the system may be programmed by, for example, dealer development staff, so as to set defaults for users that are specific to particular constraints, business relationships or regulatory constraints associated with a particular dealer. Alternatively, these defaults may be programmed by multi-IDB interface system administrators.

The matrix preferences category 1030, and its associated preferences tab allow the user to choose the visible columns in the matrix. The matrix preferences category tab 1030 may also contains a list of the available columns for the price matrix view 1220 illustrated in FIG. 2.

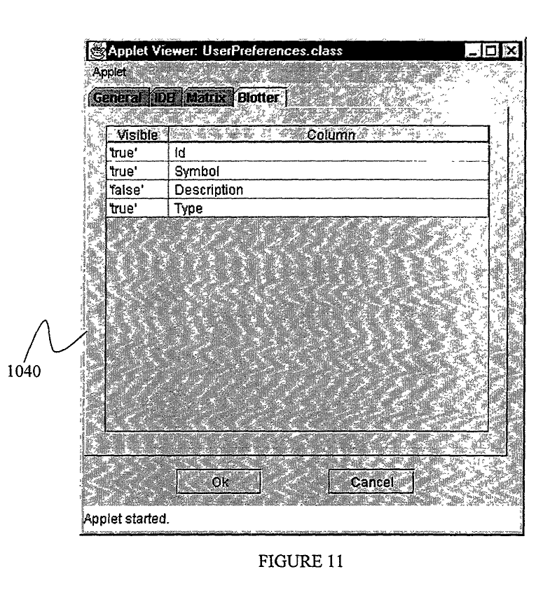

As shown in FIG. 11, the blotter preferences category tab 1040 may contain a list of the available columns for blotter view. From these lists, the user can select columns to be displayed in the price matrix view 1220 and blotter view 1240 illustrated in FIG. 2.

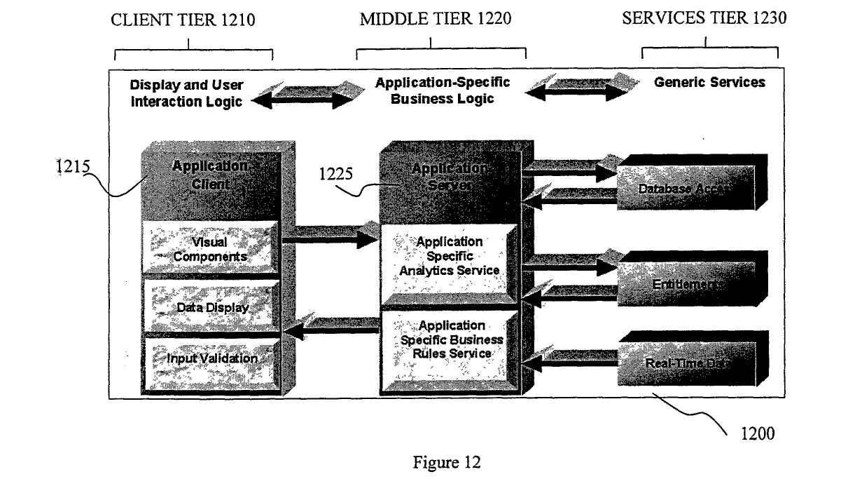

Returning to FIG. 6, the client tier 610 may use various interfaces to invoke remote methods on the middle tier 620 via a JTIWeb client stub. The middle tier 620 may implement these methods and make them available via a JTIWeb communications framework. FIG. 12 illustrates a JTIWeb framework 1200 that may be used within the architecture illustrated in FIG. 6. The JTIWeb framework 1200, in conjunction with an N-Tier architecture, offers an extremely flexible foundation for application development. A Java interface may be used to specify the API between the client application 1215 for within the client tier 1210 and the application server 1225 (implementing, e.g., the system engine 110 and FIX engine 120 functionality described in connection with FIG. 1) of the middle tier 1220 to define the business functions the middle tier 1220 provides. The middle tier 1220 can then invoke whichever system services it requires to fulfill the user's request. Results can be delivered to the client application 1215 synchronously or asynchronously over HTTP, giving web-based applications a real-time flavor, even through firewalls. The users' client application 1215 can receive data from the application server 1225 of the middle tier 1220 either synchronously, as return values from calls to the server 1225, or asynchronously, as data “pushed” out by the server 1225 in publish-subscribe mode.

Additionally, users may receive published data through a JTIWeb call back listener object that may be registered with the server 1225. In either case, the JTIWeb framework may pass data as serialized objects. All aspects of communications may be handled by the JTIWeb Framework.

A clean separation among the client, middle and service tiers 1210, 1220, 1230 through the use of standardized interfaces creates a very flexible architecture. The underlying implementation of a given service can be changed, so long as it still complies with the standard interface, no other components of the multi-IDB interface system need to be affected.

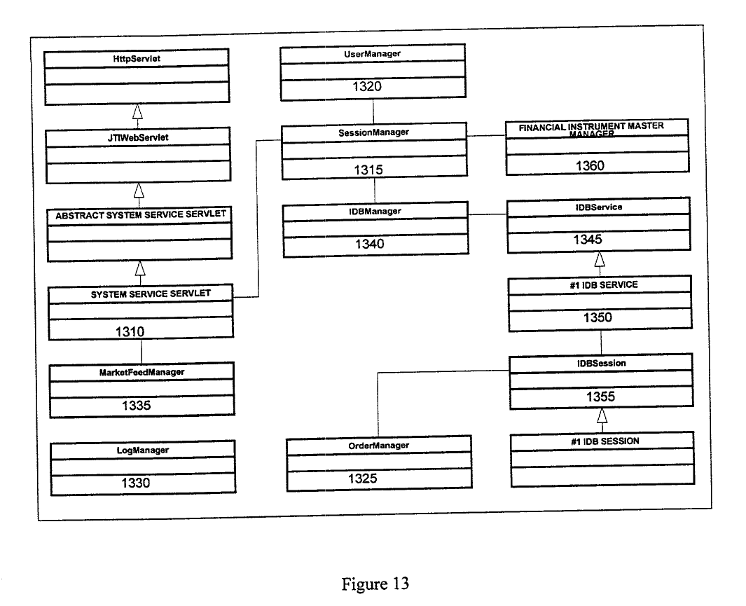

Provided that the multi-IDB interface system utilizes FIX or any other object oriented programming protocol, the middle tier 1220 may include logic allowing the handling of data objects. FIG. 13 is an illustration of the middle tier server 1225 illustrated in FIG. 12 using a class diagram overview to further explain methods that may be part of the service interface provided by the middle tier 1220. In general, these methods may delegate any method call to an appropriate handler object. The system service servlet class 1310 implements abstract system service servlets generated by a JTIC compiler, which is part of a JTIWeb framework (designed by Random Walk) used to implement some part of the middle tier 1220.

The session manager class 1315 is responsible for session management. It keeps a list of the active sessions, checks for timeouts and makes sure that each user is logged in only once. A login met hod of the class creates a session object, which holds all the relevant session information. The session manager class 1315 may also create individual sessions with each of the entitled IDBs. There is one instance of this class per server.

The user manager class 1320 uses the persistence storage device 623 illustrated in FIG. 6 (included in the data storage device 180 illustrated in FIG. 1) to retrieve and save all the user information, e.g., the user profiles including passwords and preferences. There is one instance of this class per server.

The order manager class 1325 manages order generation and subsequent recording of trades against open orders. There is one instance of this class per server. It uses the persistence storage device 623 to record all phases of an order. Specifically, the order manager class's duties may include accepting, recording and forwarding new orders to the appropriate IDB session. The order manager class 1325 duties may also include accepting trade execution notifications, updating the status of the appropriate order and sending a trade notification to an appropriate users' client application, as well as logging all order activity via the log manager class 1330.

The log manager class 1330 is responsible for storing events created by the application. Typical events include, for example, login, order placement, logout, etc. All the events may be stored in the persistent storage device 623 illustrated in FIG. 6(included in the data storage device 180 illustrated in FIG. 1) with a time stamp of the event occurrence, user information and event data.

The market feed manager class 1335 may distribute market data to the users' client applications via two different mechanisms.

First, when a user subscribes to a financial instrument market, e.g., a security market, the market feed manager 1335 may query each of the IDB market objects and obtain the market for that financial instrument market object. The markets may then be inserted into a list object that becomes the return value to the subscription request method.

The second method of distributing market data may occur when a new market feed for a financial instrument, e.g., a security, is received from an IDB. A method for notifying of a received market may be invoked by an IDB market object. A separate thread may be waiting on this method. This sleeping thread awakens and queries the IDB market object for the financial instrument market objects that have changed since the last time it was queried. For each financial instrument market object, the market feed manager 1335 may iterate through the session objects and send the financial instrument market to those users that have subscribed to that financial instrument market. The market manager class 1335 has one instance per server.

An IDB market class (not shown) may also be included, which is an interface that is implemented by the classes that maintain the markets for an IDB and interact with the market feed manager 1335. The IDB manager class 1340 manages all the available IDBs. Each IDB is registered with the manager 1340. The IDB service class 1345 is the abstract base class for an IDB service implementation like IDB service. The class 1345 is responsible for maintaining the connection with one IDB, which includes tasks like sending heartbeats to the IDB. The IDB session class 1355 is an interface, which defines all the necessary methods for using an IDB. The financial instrument master manager class 1360 deals with the financial instrument master storage device included in the financial instrument master storage device 624 illustrated in FIG. 6 and is used to retrieve descriptions of financial instruments, e.g., securities.

For stronger type safety, constant classes may be implemented as type safe enumerations in Java. Type safe enumerations enforce the range of possible values for an argument as well as the type safety of the argument. A product types class implemented as a type safe enumeration may look as shown in APPENDIX 1. For better readability of type safe enumerations, only the possible values may be defined as in the example shown in APPENDIX 2. With this construction, an example constructor for an order object might look something like that shown in APPENDIX 3.

An IDB account class (not shown) may also be included that describes an account a user has with one particular IDB. Member variables of this class include a company identification, user identification and a password. An IDB names class (not shown) may also be included, an example of which is shown in APPENDIX 4, which is an enumeration class which holds all the IDBs that the multi-IDB interface system knows.

The client application may receive the data to populate the monitor stack with market feed objects. The object may contain a market feed action type, examples of which are shown in APPENDIX 5, which indicates whether this object is a new market (ADD), replaces an existing one (UPDATE) or an existing one has to be deleted (DELETE). An order class (not shown) may be included, which describes an order. An order object can be in a set of different states, defined in order statuses. For example, a new order may be in the state PENDING_NEW. Order updates may be sent back to the client application containing the new state (e.g. PATIAL_FILLED) and the appropriate information (e.g., the trade(s)). An order statuses class (not shown) may be included as well, which may be a type safe enumerations class that defines the different statuses a order can be in, examples of which are shown in APPENDIX 6. An order types class (not shown) may be included (examples shown in APPENDIX 7), which is a type safe enumerations class that defines the different order types. Additionally, a product types class (examples shown in APPENDIX 8) may be included, which is a type safe enumerations class that defines the known product types.

A financial instrument object class (not shown) may be included, which contains all the data to describe one financial instrument. The classes may also include a system message class (not shown), which allows for status changes of the system to be sent back to the client application with system message objects A system statuses class, trade class and user class (not shown) may also be included (examples shown in APPENDIX 9).

A user levels class (not shown) may also be included (examples shown in APPENDIX 10), which may be a type safe enumerations class that defines the user levels allowed by the system. A user preferences class (not shown) may also be included that contains attributes which describe the possible user preferences.

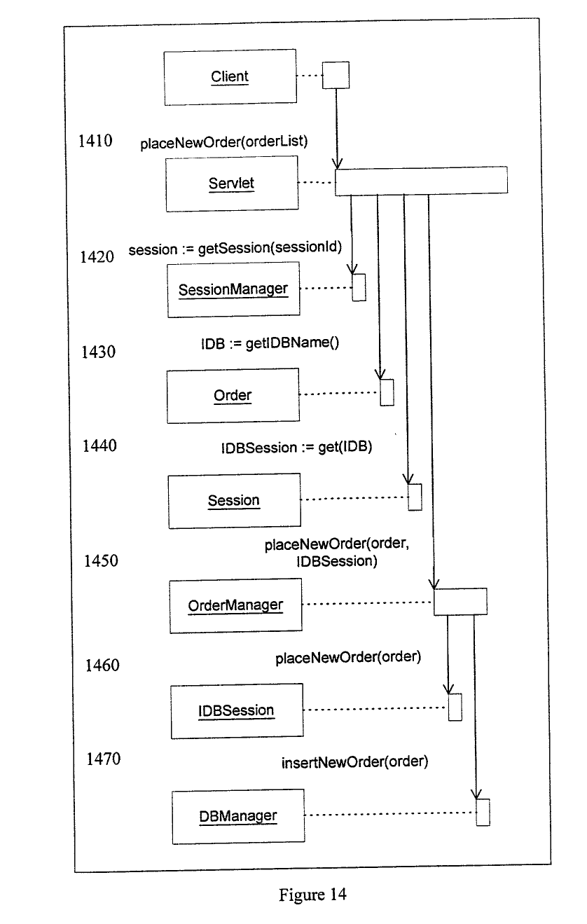

The above-described objects interact to perform the duties of the middle tier. When the servlet engine 622 accepts an order, it first sends the order to the appropriate IDB 635 and then records the order in the persistent storage device 623. FIG. 14 is a sequence diagram illustrating one implementation of an order entry process in accordance with an exemplary embodiment of the invention. Through the JTIWeb framework, a user may invoke a place new order method on the servlet engine 622, passing the engine 622 a list of orders to be placed using the user's client application at 1410. The servlet engine 622 knows the identification code of the session making the request and, at 1420, uses that code to get a session object from the session manager.

Subsequently, at 1430, for each order in the list, the servlet engine 622 identifies the IDB 635 from the order and uses the identity to identify the IDB session from the user session identity. With the order and the IDB session, at 1440, the servlet engine invokes the place new order method of the order manager. At 1450-1470, the order manager invokes the place new order method of the IDB session (1450, 1460) and inserts the order into the database via the database manager (1470).

The multi-IDB interface system may provide a trade feed function that provides notifications of trades to users against orders placed with the IDBs. Following receipt of a trade at the servlet engine, the trade is matched up with the outstanding order that preceded it. The status of the order is updated and the user at the client tier is informed of the trade via the client application.

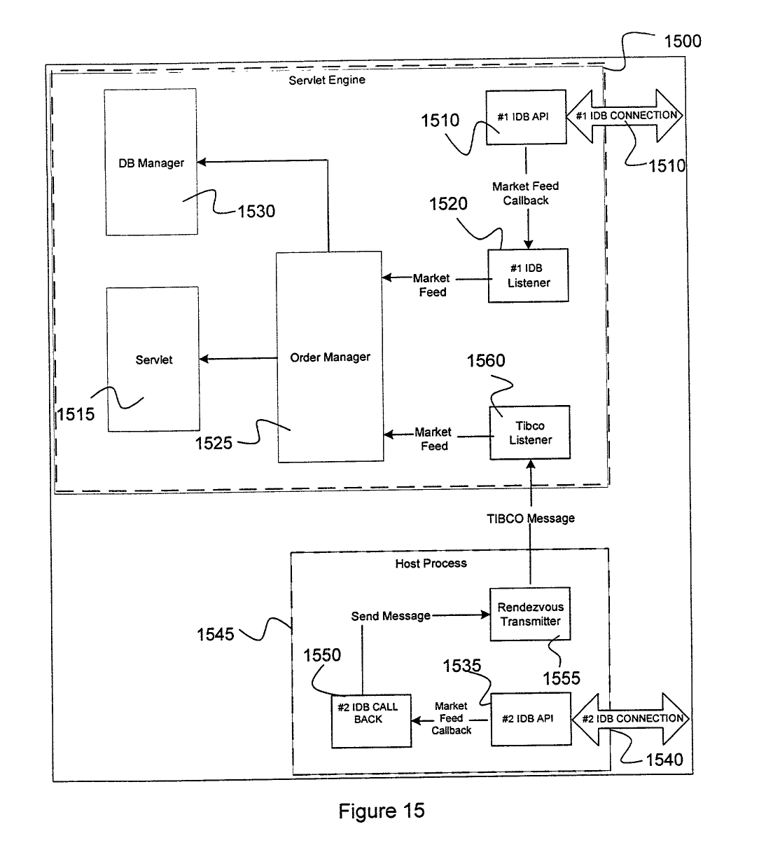

FIG. 15 is a structural diagram of one configuration of exemplary components involved in providing this trade feed function if an IDB API 1505 is, for example, a Java class API coupled to a first IDB connection 1510. In such a configuration, the servlet 1515, as part of the servlet engine 1500, invokes a method on the first IDB listener object 1520 after it receives a trade notification. The first IDB listener object 1520 translates the data into a common format and passes it to the order manager object 1525. The order manager object 1525 then invokes a method on the database manager 1530 to record the trade occurrence. Next, a message is sent to the user (if it is still logged on).

A second IDB API 1535 may be, for example, a library coupled to a second IDB connection 1540 using a host process 1545. When a trade is received, the second IDB API 1535 may invoke a call back function 1550 and pass the data in the second IDBs format. The call back function 1550 translates the data into a format suitable for Tibco messaging and invokes a method on a Tibco transmitter 1555 to send a message to a Tibco listener 1560 of the servlet engine 1500. In the servlet engine 1500 process, the message is received and passed to the order manager object 1525 where the rest of the process is identical to processing in conjunction with the first IDB 1510.

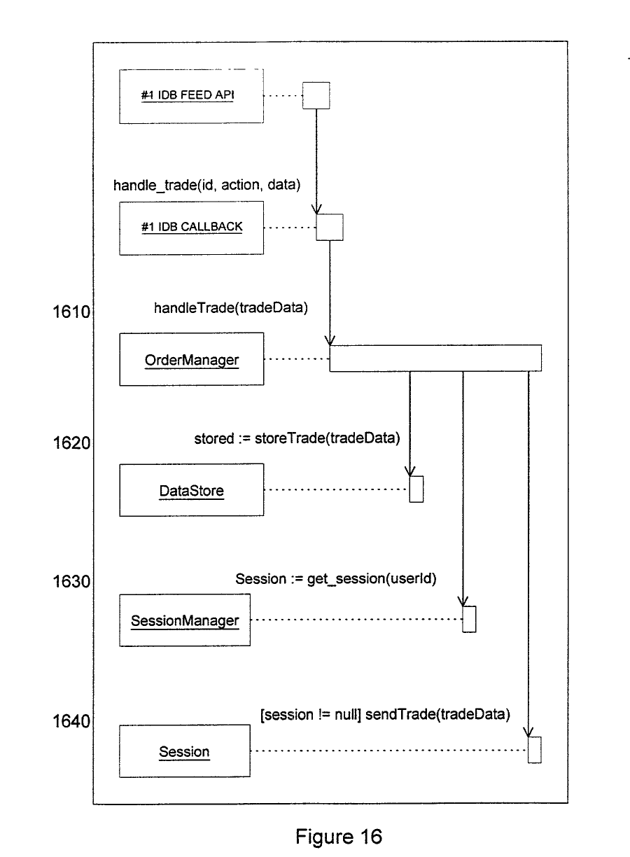

FIG. 16 is a UML sequence diagram of a first IDB trading process shown in FIG. 15. The process begins and the first IDB API calls the first IDB call back object with a trade. Embedded in the trade data structure is the system's order identification code against which the trade was made. At 1610, the first IDB call back invokes a handle trade method of the order manager object, passing the trade data in a trade object. At 1620, the order manager object then obtains the order identification code and updates the database. Using the user identification code from the order information, at 1630, the order manager object obtains the user's session from the session manager object. If it is not null, then the user is logged on and the order manager object invokes the send trade method of the session at 1640, which sends the trade to the user.

The multi-IDB interface system may also provide a market feed function that accepts continuous market updates from the IDBs and forward them to the users. For each IDB, the multi-IDB interface system subscribes to all of the financial instrument markets, e.g., securities, that the system supports. In turn, each user receives market updates only for those financial instruments to which it has subscribed with the multi-IDB interface system. The system maintains the current market of each financial instrument with each IDB so that when a user subscribes to a new financial instrument, it will immediately receive the current market.

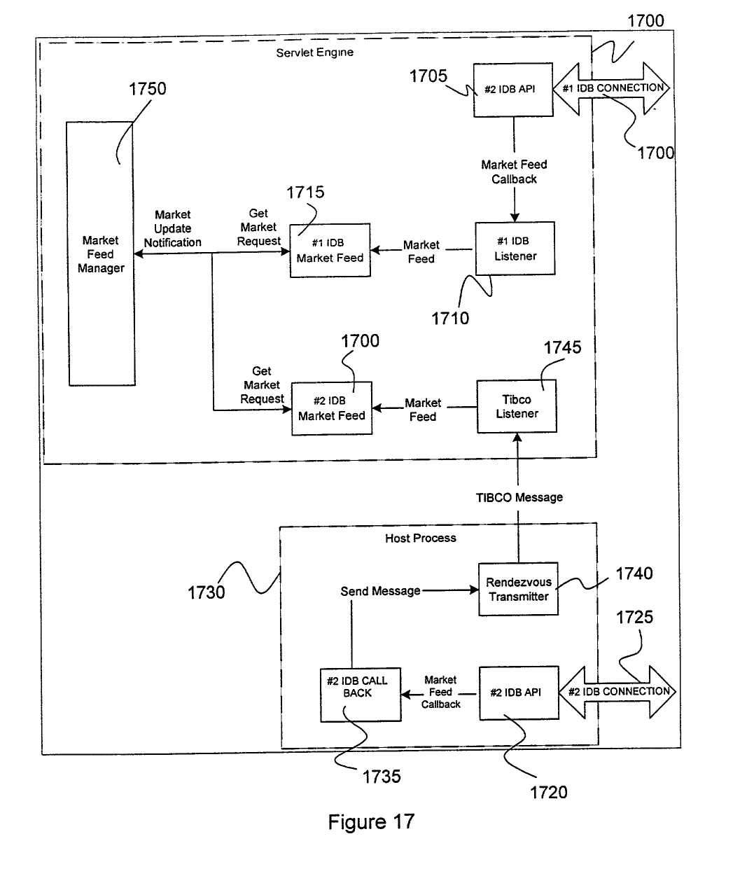

FIG. 17 is a structural representation of an exemplary configuration of the components involved in market feeds. The first IDB API 1705 may be, for example, a Java class coupled to the first IDB 1700 connection. The first IDB API 1705 may invoke a method on the first IDB listener object 1710 when it receives a market update. A market update may include a change in the market for a particular financial instrument. The first IDB listener object 1710 may translate the data into a common format and pass it to a first IDB market object 1715. At the first IDB market object 1715, the update may be integrated with the existing market for that financial instrument, and thus, now represents the new market.

The second IDB API 1720 may be, for example, a Solaris library provided by the second IDB connection 1725. This library may run in the process second IDB host 1730. When a market feed is received, the second IDB API 1720 may invoke a call back function 1735 and pass the data in the second IDBs format. The call back function 1735 may translate the data into a format suitable for Tibco messaging and invoke a method on a Tibco transmitter 1740 to send a message to a Tibco listener 1745 in the servlet engine. In the servlet engine process, the message is received and passed to the second IDB market object where it is integrated with the current market for that financial instrument.

At this point, both the first IDB market and second IDB market objects notify the market feed manager 1745 that one of their markets has been updated. The market feed manager 1750 then queries the market objects for their updated markets for the securities that have changed. The entire market may be provided to the market feed manager 1750, not just the update. The i15 market feed manager 1750 then sends the new market to those users that have subscribed to it.

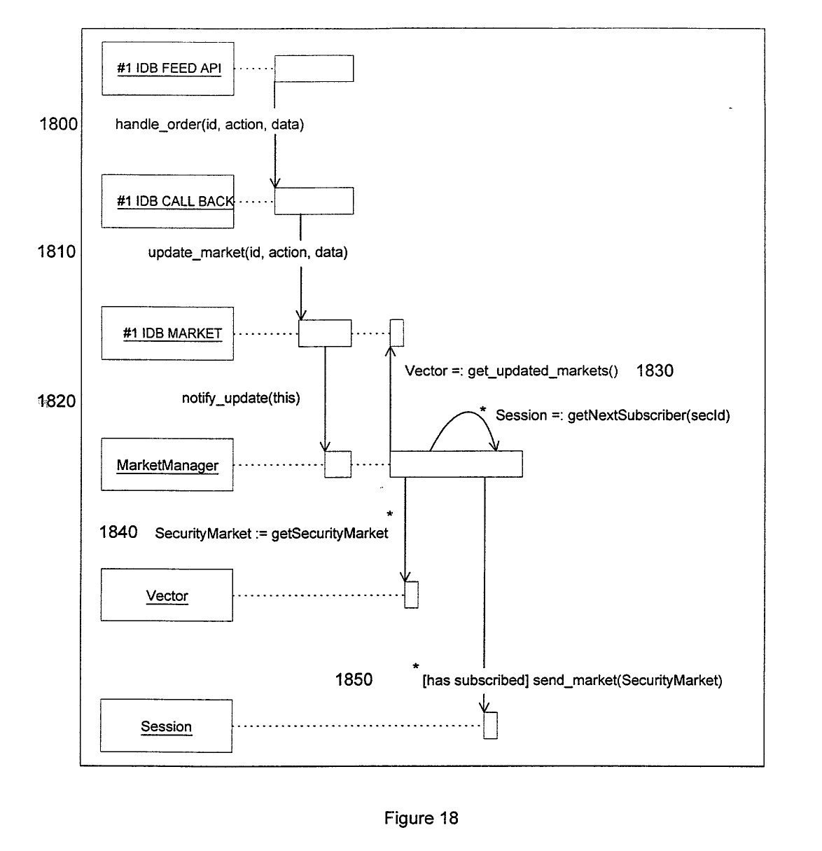

FIG. 18 documents this process in a UML sequence diagram. The process begins and the first IDB Feed API receives the update at 1800. It propagates through the first IDB call back to the first IDB market at 1810 where the update is integrated into the current market for that financial instrument, and the market for that financial instrument is placed in a vector. At 1820, it notifies the market manager of the update via the notify update function. The parameter to notify_update may be the reference to the IDB market object that was changed (in this case first IDB market). At 1830, the market manager calls get_updated_market through this reference and receives the vector containing financial instrument market objects for all of the securities whose markets have changed. For each financial instrument market in the vector, market manager gets a list of session objects that have subscribed to the financial instrument at 1840. Subsequently, at 1850, the market manager sends the financial instrument market to each subscriber, then moves on to the next financial instrument market in the vector and continues until there are no more.

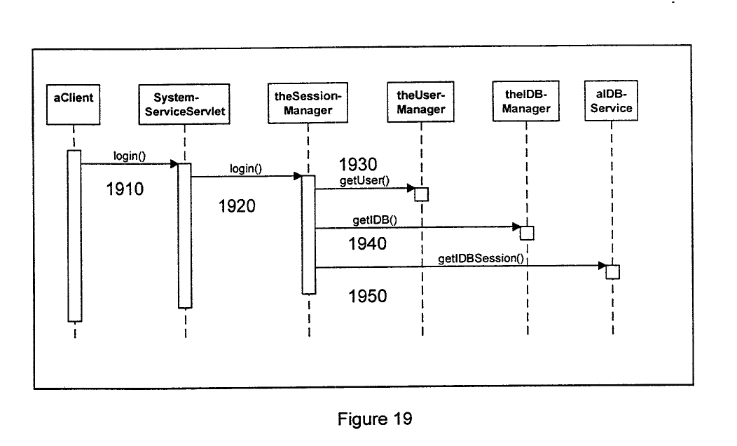

FIG. 19 illustrates an exemplary implementation of a login procedure for a user logging into the multi-IDB interface system. As shown in FIG. 19, at 1910, the client application calls a login method from the service interface providing a dealer identification code, a user identification code and a password. The JTIWeb forwards the call from the client application to the middle tier logic and invokes the login method in the servlet class. At 1920, the servlet retrieves a handle to the session manager class and invokes the login method. The session manager is responsible for maintaining all the user sessions. The login method uses the provided arguments and a session identification code which is generated by JTIWeb. During the login method, at 1930, the session manager checks to confirm that the user (e.g., company identification code/user identification code combination) is not already logged in. Next, at 1940, the session manager retrieves a user object from the user manager. This object contains all the user relevant information, for example, entitled IDBs, preferences, user level, etc. At 1950, the session manager then creates a new session object for this user and adds it to the list of active sessions.

Subsequently, the IDB manager acquires knowledge about and maintains all the available IDBs. For all the entitled IDBs, the session manager obtains the appropriate IDB service object from the IDB manager, which can be used to create an IDB session. At the end of the login method call, the user object is returned to the client applications.

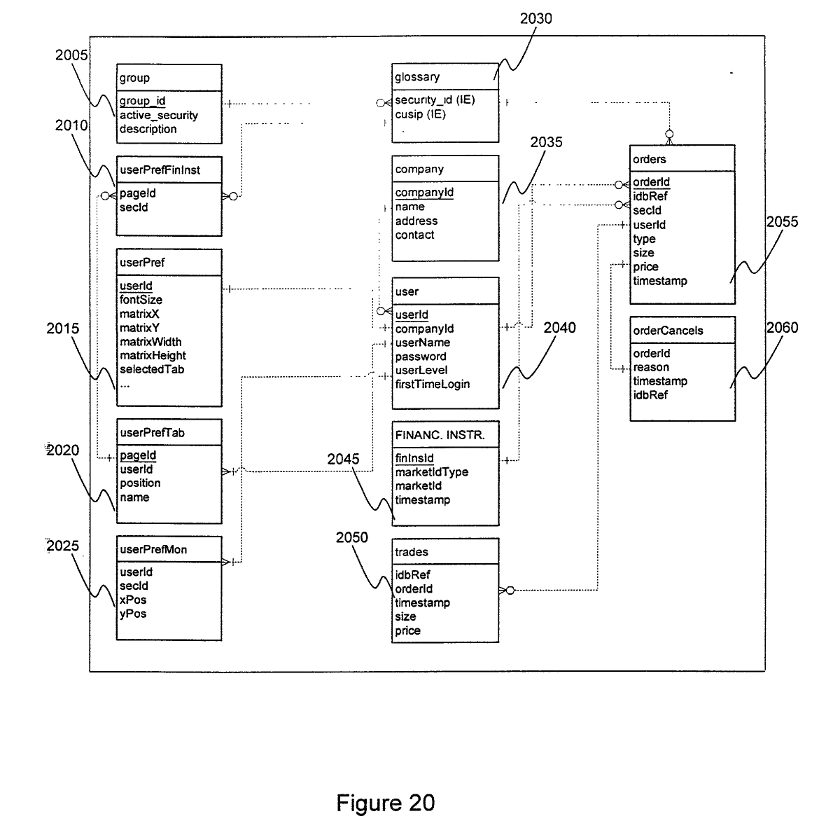

A more detailed explanation of the persistence storage device 623 illustrated in FIG. 6 (and included in the data storage device 180 illustrated in FIG. 1) and its database tables and their relationships is now provided with reference to FIG. 20, which illustrates one implementation of a database schema that may include a plurality of sub-databases. It should be appreciated that the persistence storage device 623 may be alternatively implemented as a plurality of separate databases that are accessible from a single link.

As shown in FIG. 20, the user persistence storage device 623 stores user information and provides identification data to uniquely identify a system user in other databases. The user persistence storage device 623 may include many tables, including group 2005, user financial instruments preferences 2010, user preferences 2015, user preference tab 2020, user preferences monitor 2025, glossary 2030, company 2035, user 2040, financial instruments 2045, trades 2050, orders 2055 and order cancellations 2060.

Table 1 provides an example of user table 2040. Note, the combination of user identification code and company identification code should be unique to each user.

TABLE 1

| Column Name | Type | Note |
|---|---|---|
| user identification code | integer | primary key, database supplied |
| company identification code | integer | from company table. see Note 1. |
| name | char(32) | see Note 1. |
| password | char(16) | |
| type | integer | salesperson - 1, trader - 2, trader |
| | | manager - 4, super user - 8 |
| first time login | boolean | Whether this is the fist time the |
| | | user logs in? |

Table 2 illustrates one example of the user preferences table 2015, when there is one instance of a preference per user.

TABLE 2

| Column Name | Type | Note |
|---|---|---|
| user identification code | integer | foreign key |
| fontSize | integer | 1 - small, 2 - medium, 4 - large |
| matrixX | integer | horizontal position of upper left |
| | | corner of price matrix, 0 = left |
| | | edge of screen |
| matrixY | integer | vertical position of upper left |
| | | corner of price matrix, 0 = top |
| | | edge of screen |
| matrixWidth | integer | width of price matrix screen |
| matrixHeight | integer | height of price matrix screen |
| selectedTab | integer | 0 - based index of the selected |
| | | tab in the price matrix |

Table 3 is one example of a user preferences monitor (associated with userPrefMon 2025 illustrated in FIG. 20). The user preferences monitor includes, for example, a user's saved financial instrument monitor configurations. The user preferences monitor may include multiple monitors per user, examples of which are shown in Table 3.

TABLE 3

| Column Name | Type | Note |
|---|---|---|
| user identification code | integer | foreign key |
| secId | integer | financial instrument id from |
| | | financial instrument table |
| x | integer | horizontal position of upper left |
| | | corner, 0 = left edge of screen |
| y | integer | vertical position of upper left |
| | | corner, 0 = top edge of screen |

Table 4 is one example of a user preferences tab table (associated with userPrefTabs table 2020 illustrated in FIG. 20). The user preferences tab table 2020 may include, for example, a user's saved price matrix tab pages, when there are multiple tabs per user.

TABLE 4

| Column Name | Type | Note |
|---|---|---|
| pageId | integer | primary key, database assigned |
| userId | integer | foreign key |
| position | integer | 0 - based position of tab in the price matrix |
| name | char(16) | horizontal position of upper left corner, |
| | | 0 = left edge of screen |

Table 5 is one example of a user financial instruments (e.g., securities) preferences table (associated with the userPrefSecs table 2010 illustrated in FIG. 20). The user financial instruments preferences table may include, for example, a user's saved financial instruments list for price matrix tab pages.

TABLE 6

| Column Name | Type | Note |
|---|---|---|
| pageId | integer | foreign key from userPrefsTabs |
| secId | integer | foreign key from financial instrument table |

Table 7 is one example of an order table (associated with orders table 2055 illustrated in FIG. 20), which may include, for example, a record of orders.

TABLE 7

| Column Name | Type | Note |
|---|---|---|
| orderId | integer | primary key, database generated |
| idbRef | char(32) | IDB order reference |
| secId | integer | foreign key from financial instrument table |
| userId | integer | foreign key from user table |
| type | integer | 0 - hit, 1 - lift, 2 - bid, 3 - ask |
| size | float | |
| price | float | |
| timestamp | datetime | database generated |

Table 8 is one example of a cancelled order table (associated with ordersCancels table 2060 illustrated in FIG. 20), which may include, for example, a record of cancelled orders.

TABLE 8

| Column Name | Type | Note |
|---|---|---|
| cancelId | integer | cancellation id, primary key, database |
| | | generated |
| idbRef | char(32) | IDB reference |
| orderId | integer | order id from order table |
| timestamp | datetime | database generated |

Table 9 is one example of a trades table (associated with trades table 2050 illustrated in FIG. 20), which may include, for example, a record of trades against an order in the orders table.

TABLE 9

| Column Name | Type | Note |
|---|---|---|
| confId | integer | confirmation id, primary key, database |
| | | generated |
| idbRef | char(32) | IDB reference |
| orderId | integer | order id from order table |
| timestamp | datetime | database generated |

Table 10 is one example of a financial instruments (e.g., security) table, which may include, for example, a record of financial instruments, e.g., securities, information.

TABLE 10

| Column Name | Type | Note |
|---|---|---|
| rowId | integer | System financial instrument id, primary key, |
| | | database generated |
| idType | integer | 0 - CUSIP, 1 - ISIN |
| secId | char(32) | industry id |
| timestamp | datetime | database generated |

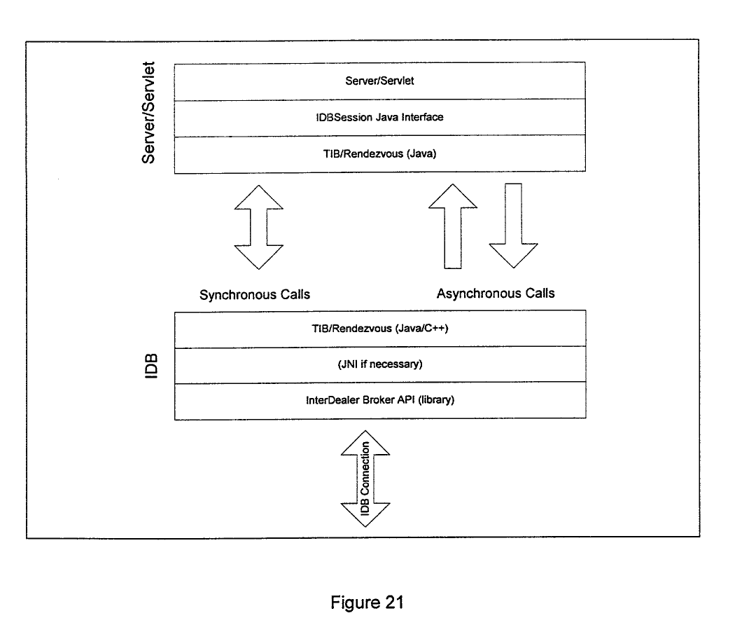

Returning to FIG. 6, and a s mentioned above, the unified Java API 632 may utilize IDB API wrappers. FIG. 21 illustrates one example of an IDB API wrapper. Each wrapped IDB API instance can run in its own process space and if necessary on its own machine depending on the characteristics of the provided IDB API.

Explanation of examples of IDB architectures and processes will now be provided to further illustrate the utility of the exemplary embodiments of the invention. An IDB may supply a Java-based API to interface with its server. The API may support a single connection to the IDB server through which market data feeds are accessed and orders can be placed and managed for multiple users. The Java class files may be packaged in a file, e.g., FirstIDB FeedApi.jar. The IDB may provide a native Java API. The IDB may be directly integrated in the system server. Alternatively, the IDB may interact with the system server using TIB/Rendezvous.

Alternatively, the IDB software API may be written in the C programming language, using a small population of functions and a relatively large population of control structures for client-to-server communication. It should be appreciated that, as opposed to an API which allows a client application to call different methods in order to invoke different pieces of server capability, this API may use the C structure passed to its PostMessage( ) function to select the desired piece of server capability. The function may employ a loop-based asynchronous messaging system to effect flow control between client application and the IDB's server. The function may provide a message loop interface and various functions through which the client application can interrogate and retrieve data from the message queue.

The security structure of such an API may be comprised of, for example, two phases of authentication: 1) session authentication, in which the client application talks to a session manager to create a unique, numbered session; and 2) trading-system authentication, in which the client application establishes the right to communicate with a given market or set of markets.

A third alternative IDB software API architecture may employ an IDB interface that employs a message-based protocol, with formatting occurring at the byte level, rather than the line level. Thus, the smallest meaningful element in a protocol message may be a byte, rather than a newline-terminated string or a symbol-delimited string token. Furthermore, since such an API exports no functions, all the intelligence is in the message itself; and the behavior of the system is completely determined by the content and sequencing of messages sent by the user. Note, however, that any successful API mapping from a procedural or object-oriented language (such as C or Java) to this protocol may be required to employ some method of mapping function calls (or method invocations) to a sequenced exchange of formatted messages.

An additional issue, that of concurrency, is raised by the fact that such a system may send once per minute (and may expect to receive with the same frequency) a “heartbeat” message, similar in function to an Internet Control Message Protocol (ICMP) ping packet, signifying that the node in question is still active and connected to the network. The behavior of the system, absent the receipt of such messages from the user, is undefined.

Such a system may or may not export a language binding for its service. Instead, it may employ a record-based message exchange protocol for all communication between the client application and the IDB's server. The client application may be responsible for correctly structuring records for transmission to the IDB's server, which may respond in kind with messages that the client application then parses according to the documented record structure.

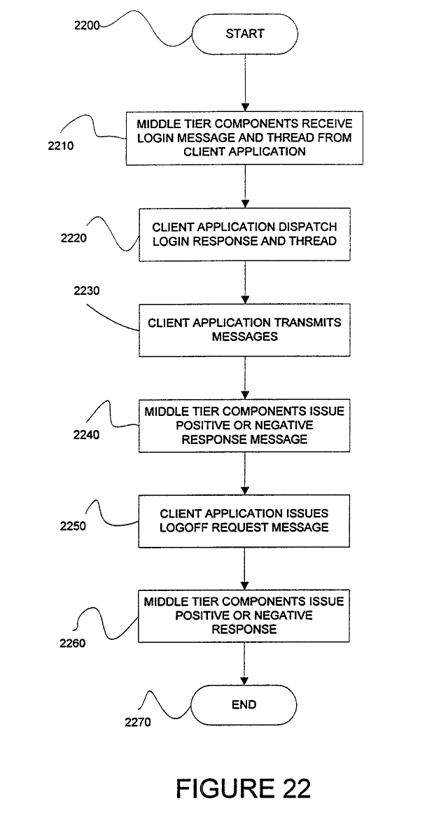

The basic flow of interaction between the client application and the middle tier components, which use this third IDB API architecture may be described as follows with to reference to FIG. 22. As shown in FIG. 22, basic flow may begin at 2200 and control proceeds to 2210. At 2210, the middle tier components of the system may receive a client application's login message composed of, e.g., a valid usemame, password, and “level of service” or access privileges requested from the system. Control then proceeds to 2220, at which the client application may dispatch a login response message as well as, or including a thread whose lifetime is guaranteed to coincide with that of the client application logged in session itself; this thread may format and transmit “heartbeat” messages to the server at a rate of, e.g., once every sixty seconds, for the duration of the connection to the server. Upon receipt of a “login response” message at 2220, the client application transmits messages to the middle tier components at 2230 including, for example, order requests, to conduct business. Control then proceeds to 2240, a which the middle tier components respond with either a positive response or negative response message. In the case of a negative response, the message will contain the error code specific to the failure.

Concurrently, with a positive response to a login request, the client application dispatches a second thread whose lifetime is coincident with that of the life of the application, as a “listener” thread. This second thread listens for user messages from the middle tier components and takes appropriate action upon receipt. The middle tier components occasionally send such messages to the client application (for example, upon a change in a bond issue or the unscheduled termination of the session) without having been “prompted” by receipt of any messages from the client application. Control then proceeds to 2250, at which the client application closes the session with the middle tier components by issuing a logoff request message. Control then proceeds to 2260, at which the middle tier components will issue a positive response in case of success and a negative response otherwise. Control may then proceed to 2270, at which the flow process may end.

A client application associated or cooperating with this third IDB API architecture is not required to load code libraries or invoke any middle tier-provided functions at any time. The advantage here is that client applications may multiplex a number of sessions onto the same communications channel, and these sessions may be differentiated on the middle tier side by the unique user identification data, which may be part of the IDB standard message header. Likewise, a client application may receive a stream of messages destined for more than one end user, demultiplexing the message stream onto multiple channels based on the same user identification data. This allows a flexible approach to the allocation of process and address space to client-server connections.

It should be appreciated that multi-IDB interface system designed in accordance with the exemplary embodiments of the invention may utilize an entitlement service, which verifies users' login access and also performs application level checking. The service may store the user login and password and other specific permissions. A user may be unique based on login identification data and company identification data. These permissions may be based on a hierarchy, which may determine the user type.

User types may include, for example, a salesperson (e.g., who may be allowed to view markets (bid/offers)), a trader (e.g., including all permitted salesperson activities as well as entry and cancellation of bids/offers (orders), hits/lifts and viewing of the user's own blotter, a trading manager (e.g., including all permitted trader activities as well as, for example, canceling orders for all permissioned products), a super user (e.g., including all permitted actives of the users above as well as, viewing all blotters for a particular company and canceling any or all orders for that company.

It is foreseeable that a user may have access to multiple product types, e.g., government issued securities, agency issued securities, repos, TBAs and corporate bonds. Similarly, a user may have access to multiple IDBs.

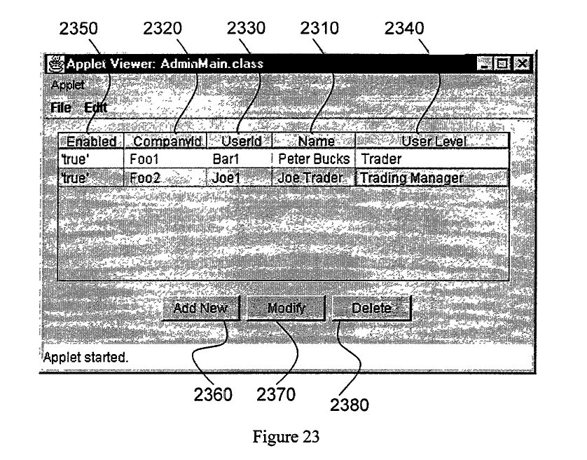

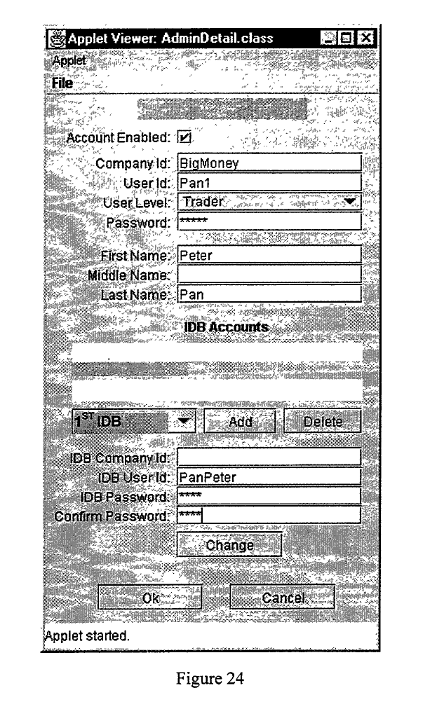

The multi-IDB interface system may use a basic administration tool to add, modify and delete users. For example, as shown FIG. 23, the administration may be performed utilizing a GUI that includes information about particular users. For example, the GUI may including user identification data 2310, a company affiliation 2320, a user ID code 2330, a user level 2340 and a status of the user's service 2350, e.g., a listing of the IDB accounts with which the user has subscriptions or access. An administrator may add new users to the service by clicking on the add new graphic 2360. The administrator may also modify the information associated with a user by first selecting the particular user to modify by highlighting the user's entry and clicking on the modify graphic 2370. Similarly, the administrator may delete a user by first highlighting the user and clicking on the delete graphic 2380. The add new graphic and modify graphics 2360, 2370 may bring up detail screens related to these administrative actions. FIG. 24 shows the detail screen of the administration tool.

It should be appreciated that the multi-IDB interface system may be used to provide a single user interface to receive from and transmit data to multiple IDBs and/or any other electronic trading system.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of the invention.

APPENDIX I
© Copyright, 2000, Onebond

```
class ProductTypes
{
  public static final ProductTypes GOVERNMENTS =
  new ProductTypes(“Governments”);
  public static final ProductTypes AGENCIES =
  new ProductTypes(“Agencies”);
  public static final ProductTypes REPOS = new ProductTypes(“Repos”);
  public static final ProductTypes TBA = new ProductTypes(“TBA”);
  public static final ProductTypes CORP = new ProductTypes(“Corp”);
  private String name;
  private ProductTypes(String name)
  {
    this.name = name;
  }
}
```

APPENDIX 2
© Copyright, 2000, Onebond

```
class ProductTypes
{
  public static final ProductTypes GOVERNMENTS;
  public static final ProductTypes AGENCIES;
  public static final ProductTypes REPOS;
  public static final ProductTypes TBA;
  public static final ProductTypes CORP;
}
```

APPENDIX 3
© Copyright, 2000, Onebond

//
// Class definition
//
class Order
{
ProductTypes productType;
int quantity;
String symbol;
double price;
public Order(ProductTypes productType, int quantity, String symbol,
double price)
}
//
// Call constructor
//
Order dummyOrder = new Order(Side.REPOS, 100, “AGY STRIP SER
1”, 110.0);

APPENDIX 4
© Copyright, 2000, Onebond

```
public final class IDBNames
{
  public static final IDBNames LIBERTY_DIRECT;
  public static final IDBNames INSTINET;
  public static final IDBNames GARBAN;
  public static final IDBNames CANTOR;
}
```

APPENDIX 5
© Copyright, 2000, Onebond

```
public final class MarketFeedActionTypes
{
    public static final MarketFeedActionTypes ADD;
    public static final MarketFeedActionTypes UPDATE;
    public static final MarketFeedActionTypes DELETE;
}
```

APPENDIX 6
© Copyright, 2000, Onebond

```
public final class OrderStatuses
{
  public static final OrderStatuses PENDING_NEW;
  public static final OrderStatuses NEW;
  public static final OrderStatuses CANCELLED_BY;
  public static final OrderStatuses REJECTED;
  public static final OrderStatuses PARTIAL_FILLED;
  public static final OrderStatuses FILLED;
}
```

APPENDIX 7
© Copyright, 2000, Onebond

```
class OrderTypes
{
  public static final OrderTypes HIT;
  public static final OrderTypes LIFT;
  public static final OrderTypes BID;
  public static final OrderTypes OFFER;
}
```

APPENDIX 8
© Copyright, 2000, Onebond

```
class ProductTypes
{
  public static final ProductTypes GOVERNMENTS;
  public static final ProductTypes AGENCIES;
  public static final ProductTypes REPOS;
  public static final ProductTypes TBA;
  public static final ProductTypes CORP;
}
```

APPENDIX 9
© Copyright, 2000, Onebond

```
public final class SystemStatuses
{
  public static final SystemStatuses INFO;
  public static final SystemStatuses WARNING;
  public static final SystemStatuses ERROR;
}
```

APPENDIX 10
© Copyright, 2000, Onebond

```
class UserLevels
{
  public static final UserLevels SALES_PERSON;
  public static final UserLevels TRADER;
  public static final UserLevels TRADING_MANAGER;
  public static final UserLevels SUPER_USER;
}
```

We claim:

1. A system providing an interface to financial instrument market data provided by at least two IDBs, the system comprising:
a client application that is configured to be deployed to a user's workstation;
a system engine configured to receive information from the client application and including or supporting a graphical user interface configured to display financial instrument market data to the user, the system engine being to receive order data from the user to perform transactions with at least one of the two IDBs using the graphical user interface and configured to receive financial instrument market data contained in at least two data feeds provided by at least two IDBs, to enable consolidation of financial instrument market data that is specific to at least one financial instrument based on the data received from the at least two IDBs and to transmit order data from the user to at least one of the two IDBs.

2. The system of claim 1, wherein each IDB provides a data feed to the at least one group of users that includes financial instrument identification data, price data and quantity data.

3. The system of claim 1, wherein the system manages and outputs financial instrument market data received from the at least two IDBs and receives data from the at least one user, the user's data being related to the financial instrument market data from at least one of the two IDBS.

4. The system of claim 1, wherein installation and upgrades of the client application are performed by downloading client application software.

5. The system of claim 1, wherein the client application is platform independent.

6. The system of claim 1, further comprising a FIX engine coupled to the system engine and configured to provide connectivity between the multi-IDB interface system and at least one of the user's transaction administration or management systems or applications.

7. The system of claim 1, wherein the graphical user interface is configured to display best prices in at least one financial instrument market on one screen based on the financial instrument market data provided by the at least two IDBs.

8. The system of claim 1, wherein the at least two IDBs each have at least one associated IDB feed and an API.

9. The system of claim 1, wherein the system engine consolidates bid and offer price and quantity data for at least one financial instrument based on the financial instrument market data provided by the at least two IDBs.

10. The system of claim 1, wherein the system engine resides on at least one server located at a user site and server side functionality is provided via a local area network at the user site to be accessible by the user work station using a client application that has been downloaded to the user work station.

11. The system of claim 1, wherein at least part of functionality associated with the client application is supported by processes run on the system engine.

12. The system of claim 11, wherein the system engine acts as an application service provider to provide the functionality supported by processes run on the system engine to the user.

13. The system of claim 12, wherein the functionality delivered by the system engine acting as an application service provider is delivered to the user via a private communication network.

14. The system of claim 12, wherein the functionality delivered by the system engine acting as an application service provider is delivered to the user via a public communication network.

15. The system of claim 12, wherein the functionality delivered by the system engine acting as an application service provider is delivered to the user via the Internet.

16. The system of claim 12, wherein the functionality delivered by the system engine acting as an application service provider is delivered to the user via an extranet.

17. The system of claim 12, wherein the functionality delivered by the system engine acting as an application service provider includes authentication and entitlement determinations.

18. The system of claim 11, wherein the functionality delivered by the system engine acting as an application service provider includes consolidation of prices and sizes across a minimum of two IDBs.

19. The system of claim 11, wherein the functionality delivered by the system engine acting as an application service provider includes separate display of bid and offer prices.

20. The system of claim 11, wherein the functionality delivered by the system engine acting as an application service provider includes separate display of bid and offer sizes.

21. The system of claim 11, wherein the functionality delivered by the system engine acting as an application service provider includes display of a consolidated IDB stack or stacks corresponding to particular IDBs.

22. The system of claim 11, wherein the functionality delivered by the system engine acting as an application service provider includes hitting or lifting of current market information from at least one IDB.

23. The system of claim 11, wherein the functionality delivered by the system engine acting as an application service provider includes transmission of orders from a user to a minimum of two IDBs.

24. The system of claim 11, wherein the functionality delivered by the system engine acting as an application service provider includes cancellation of financial instrument orders.

25. The system of claim 11, wherein the functionality delivered by the system engine acting as an application service provider includes providing receipt confirmations of executed trades to the user.

26. The system of claim 11, wherein the functionality delivered by the system engine acting as an application service provider includes printing of order, trade, order cancellation and market reports.

27. The system of claim 11, wherein the functionality delivered by the system engine acting as an application service provider includes issuance and processing of security certificates.

28. The system of claim 11, wherein the functionality delivered by the system engine acting as an application service provider includes support of programmable function keys used with the client application.

29. The system of claim 1, wherein the system engine manages connectivity to the IDBs and a system operated by the user.

30. The system of claim 29, wherein the system engine translates financial instrument market data from the at least two IDBs into a format that is readable by the multi-IDB interface system.

31. The system of claim 1, wherein the system engine is implemented as an application that coordinates the sorting and display of the financial instrument market data provided the at least two IDBs.

32. The system of claim 1, further comprising a persistence storage device coupled to the system engine and including a record of all orders, trades and a user service profile.

33. The system of claim 1, wherein the system engine operates to provide routing of orders data from the user to at least one IDB identified in the order data.

34. The system of claim 1, wherein the system engine manages an inventory of financial instruments market data that a user has subscribed to receive.

35. The system of claim 33, wherein the system engine identifies update information in the financial instrument market data received from the at least two IDBs and provides that update information to users who have subscribed to receive that update information.

36. The system of claim 1, further comprising a FIX engine coupled to the system engine and configured to support STP processing to at least one of the user's transaction administration or management systems or applications.
